(19) United States
(12) Patent Application Publication
(10) Pub. No.: US 2026/0313254 A1
(43) Pub. Date: Oct. 8, 2026

(54) PHOTODETECTION ELEMENT AND ELECTRONIC APPARATUS

(71) Applicant: Sony Semiconductor Solutions Corporation, Kanagawa (JP)

(72) Inventor: Kazutoshi Kodama, Tokyo (JP)

(21) Appl. No.: 19/164,469

(22) PCT Filed: Feb. 14, 2024
(86) PCT No.: PCT/JP24/04991

§ 371 Date: Sep. 11, 2025

(30) Foreign Application Priority Data
Apr. 3, 2023 (JP) 2023-060406

(51) Int. Cl. H04N 25/47; H04N 25/77; H04N 25/78

(52) U.S. Cl. CPC H04N 25/47; H04N 25/77; H04N 25/78

(57) ABSTRACT

Photodetection elements and electronic apparatus that shorten a detection cycle of an event signal are disclosed. In one example, a photodetection element includes a light receiving unit that photoelectrically converts incident light to generate an electric signal, and a comparison unit which outputs an event signal when an amount of change in the electric signal exceeds or falls below a threshold A first recording unit is connected to an output terminal of the comparison unit, records the event signal, and outputs the event signal. A second recording unit is connected to the first recording unit, records the event signal from the first recording unit, and outputs the event signal.

### TECHNICAL FIELD

The present disclosure relates to a photodetection element and an electronic apparatus.

### BACKGROUND ART

A photodetection element which detects an event signal in real time when a light amount of a pixel exceeds a threshold has been developed. The photodetection element which detects such an event signal is called an event vision sensor (EVS).

### CITATION LIST

### Patent Document

Patent Document 1: Japanese Patent Application Laid-Open No. 2021-048554

### SUMMARY OF THE INVENTION

### Problems to be Solved by the Invention

In such a photodetection element, a detection cycle having, as one cycle, a detection period for detecting an event signal, a readout period for reading out a recorded event signal, a reset period for resetting a threshold for detecting an event signal, or the like is repeatedly executed. It is desired to shorten this detection cycle to enable the photodetection element to operate at a high speed.

The present technology has been made in view of such a problem, and provides a photodetection element and an electronic apparatus capable of shortening a detection cycle of an event signal.

### Solutions to Problems

A photodetection element according to one aspect of the present disclosure includes: a light receiving unit that photoelectrically converts incident light to generate an electric signal; a comparison unit which outputs an event signal when an amount of change in the electric signal exceeds or falls below a threshold; a first recording unit that is connected to an output terminal of the comparison unit, records the event signal, and outputs the event signal; and a second recording unit that is connected to the first recording unit, records the event signal from the first recording unit, and outputs the event signal.

The first recording unit records a next event signal from the comparison unit during a readout period in which the event signal recorded in the second recording unit is being read out.

The photodetection element further includes: a first switching element that is connected between an input terminal of the comparison unit and the output terminal of the comparison unit; a control unit that is provided between an output terminal of the first recording unit and the first switching element and controls the first switching element on the basis of the event signal output from the first recording unit; and a first readout line that is connected to an output terminal of the second recording unit, in which when the first switching element is in a conductive state, the second recording unit outputs the event signal to the first readout line.

The photodetection element further includes: a third recording unit that is connected to the output terminal of the comparison unit and records the event signal; and a fourth recording unit that is connected to the third recording unit and records the event signal from the third recording unit.

The third recording unit records a next event signal from the comparison unit during a readout period in which the event signal recorded in the fourth recording unit is being read out.

The photodetection element further includes: a first switching element that is connected between an input terminal of the comparison unit and the output terminal of the comparison unit; a control unit that is provided between output terminals of the first and third recording units and the first switching element and controls the first switching element on the basis of the event signal output from the first and third recording units; a first readout line that is connected to an output terminal of the second recording unit; and a second readout line that is connected to an output terminal of the fourth recording unit, in which when the first switching element is in a conductive state, the event signal recorded in the second recording unit is read out to the first readout line, and the event signal recorded in the fourth recording unit is read out to the second readout line.

The comparison unit compares the amount of change with a first threshold and outputs a first event signal in a first period, and compares the amount of change with a second threshold different from the first threshold and outputs a second event signal in a second period following the first period, the first recording unit records the first event signal in the first period, the third recording unit records the second event signal in the second period, and when the first switching element is in a conductive state, the second recording unit records the first event signal from the first recording unit and outputs the first event signal to the first readout line, and the fourth recording unit records the second event signal from the third recording unit and outputs the second event signal to the second readout line.

The control unit resets voltages at an input terminal and an output terminal of the comparison unit to a voltage between the first threshold and the second threshold by bringing the first switching element into a conductive state.

The control unit controls the first switching element on the basis of the event signal recorded in each of the first and third recording units.

The photodetection element further includes: an inverter that is connected to an output terminal of one of the first and second recording units; and a first logic gate that outputs, to the first readout line, a logical AND of an output signal of another of the first and second recording units and an output signal of the inverter.

The photodetection element further includes: an inverter that is connected to an output terminal of one of the first and second recording units; a first logic gate that outputs, to the first readout line, a logical AND of an output signal of another of the first and second recording units and an output signal of the inverter; an inverter that is connected to an output terminal of one of the third and fourth recording units; and a second logic gate that outputs, to the second readout line, a logical AND of an output signal of another of the third and fourth recording units and the output signal of the inverter.

The photodetection element further includes: a third logic gate that outputs a logical AND of output signals of the first and second recording units to the control unit, in which the control unit controls the first switching element on the basis of an output signal of the third logic gate.

The photodetection element further includes: a third logic gate that outputs a logical AND of output signals of the first and second recording units to the control unit; and a fourth logic gate that outputs a logical AND of output signals of the third and fourth recording units to the control unit, in which the control unit controls the first switching element on the basis of output signals of the third and fourth logic gates.

The comparison unit compares the amount of change with a first threshold and outputs a first event signal in a first period, and compares the amount of change with a second threshold different from the first threshold and outputs a second event signal in a second period following the first period, the first recording unit. alternately records the first event signal and the second event signal, and when the first switching element is in a conductive state, the second recording unit records the first event signal from the first recording unit and outputs the first event signal to the first readout line, or records the second event signal from the first recording unit and outputs the second event signal to the first readout line.

The photodetection element further includes: a first switching element that is connected between an input terminal of the comparison unit and the output terminal of the comparison unit; a control unit that is provided between the output terminals of the first and third recording units and the first switching element and controls the first switching element on the basis of the event signal output from the first and third recording units; a first switch circuit that is connected to output terminals of the second and fourth recording units; and a first readout line that is connected to an output terminal of the first switch circuit, in which the first switch circuit selectively connects the output terminal of any one of the second and fourth recording units to the first readout line.

The photodetection element further includes: a plurality of the light receiving units; a plurality of the comparison units that is provided corresponding to the plurality of light receiving units; a plurality of the first recording units; a plurality of the second recording units that is provided corresponding to the plurality of first recording units; a buffer that is provided between the plurality of comparison units and the plurality of first recording units; a second switch circuit that is provided between an input terminal of the buffer and the plurality of comparison units, and connects a selected comparison unit selected from the plurality of comparison units to the input terminal of the buffer; and a third switch circuit that is provided between an output terminal of the buffer and the plurality of first recording units and connects a selected first recording unit selected from the plurality of first recording units to the output terminal of the buffer.

A photodetection element according to another aspect of the present disclosure includes: a light receiving unit that photoelectrically converts incident light to generate an electric signal; a comparison unit that compares an amount of change in the electrical signal generated by the light receiving unit with a threshold and outputs an event signal; and first and second recording units that are connected in parallel to an output terminal of the comparison unit, in which when one of the first and second recording units records the event signal, another of the first and second recording units outputs the event signal.

The photodetection element further includes: a second switching element that is connected between the output terminal of the comparison unit and the first recording unit; a third switching element that is connected between the output terminal of the comparison unit and the second recording unit; a fourth switching element that is connected between the first recording unit and the first readout line; a fifth switching element that is connected between the second recording unit and the first readout line; a sixth switching element that is connected between the first recording unit and the control unit; and a seventh switching element that is connected between the second recording unit and the control unit, in which when the first recording unit records the event signal and the second recording unit outputs the event signal, the second, fifth, and sixth switching elements are in a conductive state, and the third, fourth, and seventh switching elements are in a non-conductive state, and when the second recording unit records the event signal and the first recording unit outputs the event signal, the third, fourth, and seventh switching elements are in a conductive state, and the second, fifth, and sixth switching elements are in a non-conductive state.

An electronic apparatus according to one aspect of the present disclosure includes: a photodetection element including a light receiving unit that photoelectrically converts incident light to generate an electric signal, a comparison unit which outputs an event signal when an amount of change in the electric signal exceeds or falls below a threshold, a first recording unit that is connected to an output terminal of the comparison unit, records the event signal, and outputs the event signal, and a second recording unit that is connected to the first recording unit, records the event signal from the first recording unit, and outputs the event signal.

An electronic apparatus according to another aspect of the present disclosure includes: a photodetection element including a light receiving unit that photoelectrically converts incident light to generate an electric signal, a comparison unit that compares an amount of change in the electrical signal generated by the light receiving unit with a threshold and outputs an event signal, and first and second recording units that are connected in parallel to an output terminal of the comparison unit, in which when one of the first and second recording units records the event signal, another of the first and second recording units outputs the event signal.

### BRIEF DESCRIPTION OF DRAWINGS

FIG. 1 is a block diagram illustrating a configuration example of a photodetection element according to a first embodiment.

FIG. 2 is a diagram illustrating an example of a stacked structure of a solid-state imaging element according to the first embodiment.

FIG. 3 is an example of a plan view of a light receiving chip.

FIG. 4 is an example of a plan view of a pixel array unit.

FIG. 5 is an example of a plan view of a detection chip.

FIG. 6 is an example of a plan view of a detection unit.

FIG. 7 is a block diagram illustrating an example of a configuration of an event detection circuit.

FIG. 8 is a circuit diagram illustrating an example of a configuration of the event detection circuit, a recording region, and a control unit.

FIG. 9 is a timing diagram illustrating an operation example of the photodetection element according to the first embodiment.

FIG. 10 is a timing diagram illustrating an operation example of a photodetection element according to a second embodiment.

FIG. 11 is a circuit diagram illustrating an example of a configuration of an event detection circuit, a recording region, and a control unit according to a third embodiment.

FIG. 12 is a timing diagram illustrating an operation example of a photodetection element according to the third embodiment.

FIG. 13 is a timing diagram illustrating an operation example of the photodetection element according to the third embodiment.

FIG. 14 is a circuit diagram illustrating an example of a configuration of an event detection circuit, a recording region, and a control unit according to a fourth embodiment.

FIG. 15 is a timing diagram illustrating an operation example of a photodetection element according to the fourth embodiment.

FIG. 16 is a timing diagram illustrating an operation example of the photodetection element according to the fourth embodiment.

FIG. 17 is a circuit diagram illustrating an example of a configuration of an event detection circuit, a recording region, and a control unit according to a fifth embodiment.

FIG. 18 is a timing diagram illustrating an operation example of a photodetection element according to the fifth embodiment.

FIG. 19 is a circuit diagram illustrating an example of a configuration of an event detection circuit, a recording region, and a control unit according to a sixth embodiment.

FIG. 20 is a timing diagram illustrating an operation example of a photodetection element according to the sixth embodiment.

FIG. 21 is a circuit diagram illustrating an example of a configuration of an event detection circuit, a recording region, and a control unit according to a seventh embodiment.

FIG. 22 is a circuit diagram illustrating an example of a configuration of an event detection circuit, a recording region, and a control unit according to an eighth embodiment.

FIG. 23 is a timing diagram illustrating an operation example of a photodetection element according to the eighth embodiment.

FIG. 24 is a block diagram illustrating an example of a schematic configuration of a vehicle control system.

FIG. 25 is an explanatory diagram illustrating an example of installation positions of an outside-vehicle information detecting section and an imaging section.

### MODE FOR CARRYING OUT THE INVENTION

Hereinafter, specific embodiments to which the present technology is applied will be described in detail with reference to the drawings. The drawings are schematic or conceptual, and the ratio of each part and the like are not necessarily the same as actual ones. In the specification and the drawings, similar elements to those described above concerning the previously described drawings are denoted by the same reference signs, and detailed descriptions thereof are appropriately omitted.

### First Embodiment

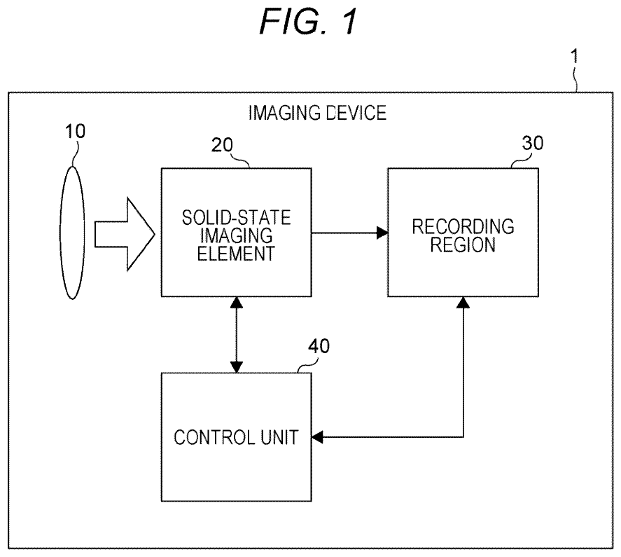

FIG. 1 is a block diagram illustrating a configuration example of a photodetection element 1 according to a first embodiment. The photodetection element 1 is, for example, an EVS or a dynamic vision sensor (DVS). The photodetection element 1 includes an imaging lens 10, a solid-state imaging element 20, a recording region 30, and a control unit 40. As the photodetection element 1, for example, an electronic apparatus such as a camera mounted on an industrial robot, an in-vehicle camera, and a monitoring camera are assumed.

The imaging lens 10 condenses incident light and guides the light to the solid-state imaging element 20. The solid-state imaging element 20 photoelectrically converts incident light to generate a voltage signal corresponding to the amount of received light, and detects a change in the amount of received light as an event signal on the basis of the amount of change in the voltage signal. The detected event signal is output to the recording region 30.

The recording region 30 records the event signal from the solid-state imaging element 20. The recording region 30 may be, for example, a semiconductor memory such as a latch circuit, a dynamic random access memory (DRAM), or a flash memory. The internal configuration of the recording region 30 will be described in more detail later.

The control unit 40 includes a microcomputer including, for example, a central processing unit (CPU), a read only memory (ROM), a RAM, and the like, and controls the operation of the photodetection element 1 by the CPU executing processing according to a program. In particular, the control unit 40 controls the solid-state imaging element 20 to execute the above-described event signal detection operation, controls the recording region 30 to record an event signal, and executes processing of reading out an event signal from the recording region 30.

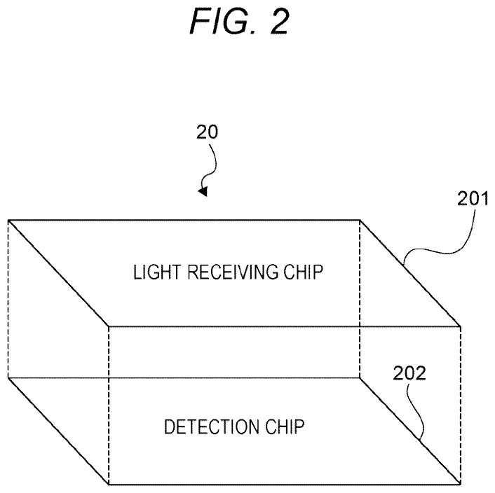

FIG. 2 is a diagram illustrating an example of a stacked structure of the solid-state imaging element 20 according to the first embodiment. The solid-state imaging element 20 includes a detection chip 202 and a light receiving chip 201 stacked on the detection chip 202. The light receiving chip 201 and the detection chip 202 in such a stacked structure are electrically connected via a connection portion such as a via. Note that the chips can be connected by Cu-Cu bonding or a bump instead of a via.

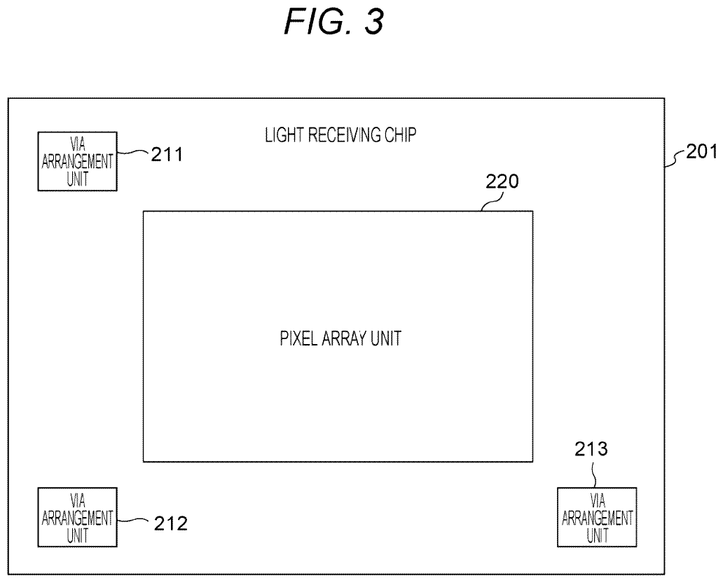

FIG. 3 is an example of a plan view of the light receiving chip 201. The light receiving chip 201 is provided with a pixel array unit 220 and via arrangement units 211, 212, and 213. In the via arrangement units 211, 212, and 213, vias connected to the detection chip 202 are arranged.

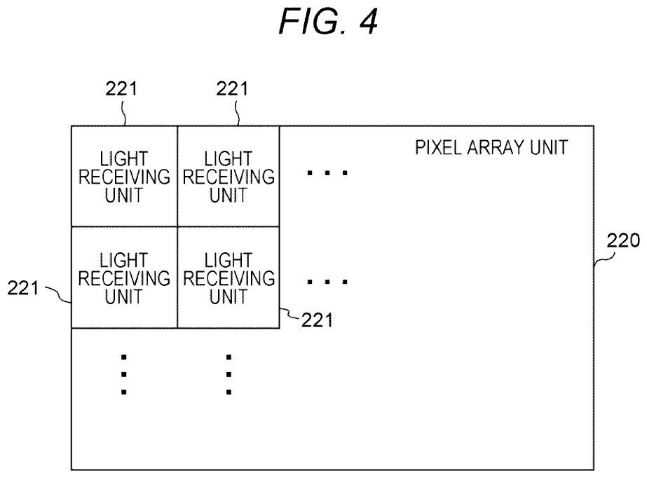

FIG. 4 is an example of a plan view of the pixel array unit 220. In the pixel array unit 220, a plurality of light receiving units 221 is arranged in a two-dimensional lattice pattern. The light receiving unit. 221 is, for example, a photodiode. The light receiving unit 221 photoelectrically converts incident light to generate a photocurrent. A pixel address including a row address and a column address is assigned to each of the light receiving units 221.

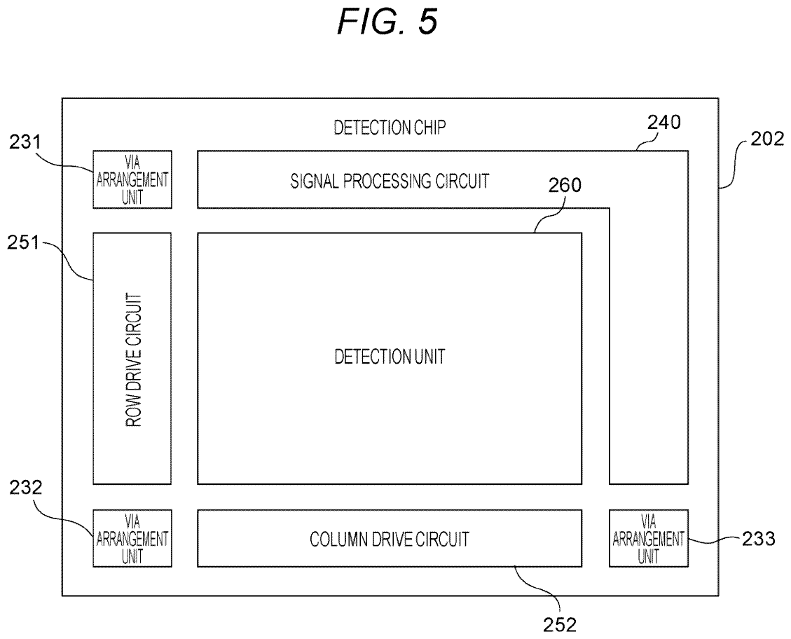

FIG. 5 is an example of a plan view of the detection chip 202. The detection chip 202 is provided with via arrangement units 231, 232, and 233, a signal processing circuit 240, a row drive circuit 251, a column drive circuit 252, and a detection unit 260. In the via arrangement units 231, 232, and 233, vias connected to the light receiving chip 201 are arranged.

The row drive circuit 251 selects a row address of the pixel array unit 220 and causes the detection unit 260 to output a photocurrent corresponding to the row address. The column drive circuit 252 selects a column address of the pixel array unit 220 and causes the detection unit 260 to output a photocurrent corresponding to the column address.

The detection unit 260 detects an event signal by quantizing a voltage signal obtained by logarithmically converting the input photocurrent, and outputs the detected event signal to the signal processing circuit 240. An event indicates that the amount of change in the voltage signal obtained by logarithmically converting the photocurrent exceeds or falls below a predetermined threshold. The event signal is activated (for example, raised) when the event occurs. The event signal is a signal quantized (binarized) by a quantizer 330. The signal processing circuit 240 performs predetermined signal processing on the event signal output from the detection unit 260 and outputs the signal to the recording region 30.

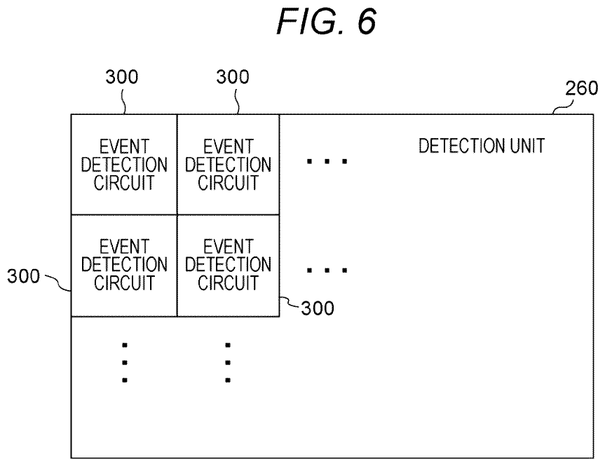

FIG. 6 is an example of a plan view of the detection unit 260. In the detection unit 260, a plurality of event detection circuits 300 is arranged in a two-dimensional lattice pattern. Each of the event detection circuits 300 has a pixel address assigned, and is connected to the light receiving unit 221 having the same address. The event detection circuit 300 quantizes a voltage signal according to the photocurrent from the corresponding light receiving unit 221 and outputs the same as the event signal.

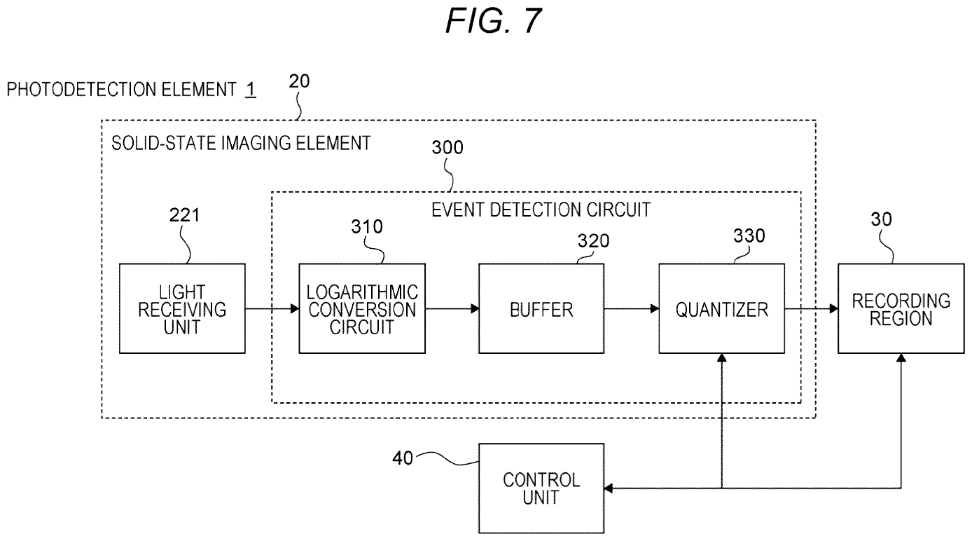

FIG. 7 is a block diagram illustrating an example of a configuration of the event detection circuit 300.

The event detection circuit 300 includes a logarithmic conversion circuit 310, a buffer 320, and the quantizer 330.

The logarithmic conversion circuit 310 converts the photocurrent from the corresponding light receiving unit 221 into a logarithmically converted voltage signal. The logarithmic conversion circuit 310 supplies the converted voltage signal to the buffer 320.

The buffer 320 corrects the voltage signal from the logarithmic conversion circuit 310. The buffer 320 outputs the corrected voltage signal to the quantizer 330.

The quantizer 330 compares the amount of change in the input voltage signal with a predetermined threshold (comparison reference voltage), and detects an event signal indicating that the change amount exceeds or falls below the threshold. The quantizer 330 quantizes the reduced voltage signal into a digital signal and outputs, as the event signal, the digital signal to the recording region 30.

The control unit 40 controls the operation of the quantizer 330 and controls the readout of the detection signal recorded in the recording region 30.

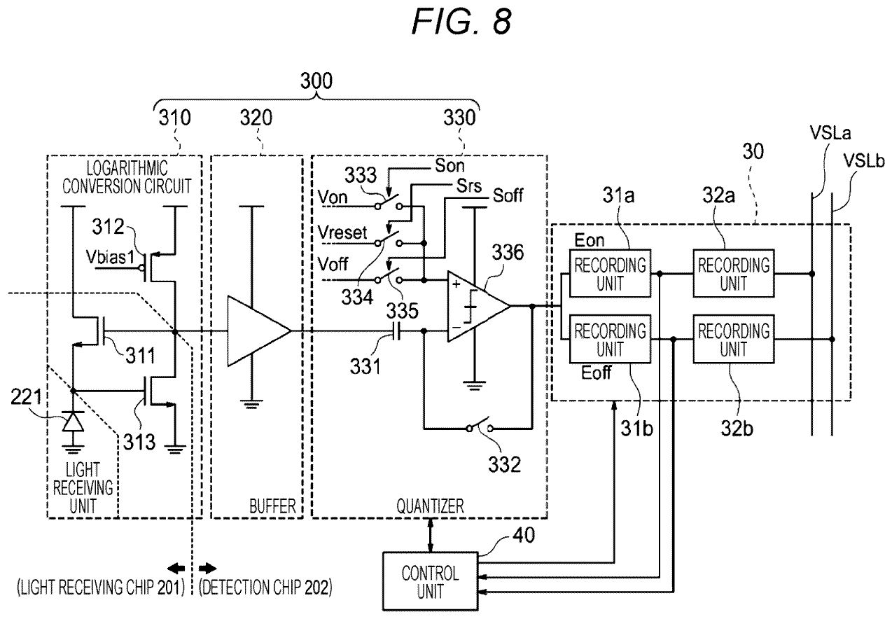

FIG. 8 is a circuit diagram illustrating an example of a configuration of the event detection circuit 300, the recording region 30, and the control unit 40. The logarithmic conversion circuit 310 includes N-type transistors 311 and 313 and a P-type transistor 312. For example, metal-oxide-semiconductor (MOS) transistors are used as these transistors.

A source of the N-type transistor 311 is connected to a cathode of the light receiving unit 221, and a drain thereof is connected to a power supply line. The P-type transistor 312 and the N-type transistor 313 are connected in series between the power supply line and the ground. Furthermore, the connection point of the P-type transistor 312 and the N-type transistor 313 is connected to the gate of the N-type transistor 311 and the input terminal of the buffer 320. Furthermore, a predetermined bias voltage Vbias1 is applied to the gate of the P-type transistor 312.

Drains of the N-type transistors 311 and 313 are connected to a power supply side, and such a circuit is called a source follower. The photocurrent from the light receiving unit 221 is converted into a logarithmically converted voltage signal by the two source followers connected in a loop. Furthermore, the P-type transistor 312 supplies a constant current to the N-type transistor 313.

The above-described logarithmic conversion circuit 310 converts the intensity of light received by the light receiving unit 221 into a logarithmically converted voltage signal.

Note that the ground of the light receiving chip 201 and the ground of the detection chip 202 are separated from each other for a countermeasure against interference. Furthermore, the light receiving unit 221 and the N-type transistors 311 and 313 of the event detection circuit 300 are arranged on the light receiving chip 201, and the event detection circuit 300 other than the N-type transistors 311 and 313 is arranged on the detection chip 202.

The quantizer 330 includes a capacitor 331, switching elements 332, 333, 334, and 335, and a comparator 336. Each switching element is caused to be conductive according to an operation control signal of the control unit 40. As the switching elements 332, 333, 334, and 335, for example, MOS transistors are used.

One end of the capacitor 331 is connected to the output terminal of the buffer 320, and another end thereof is connected to the inverting input terminal of the comparator 336. Therefore, a voltage as the amount of change in the voltage signal from the buffer 320 becomes a voltage signal input to the comparator 336. That is, a voltage signal corresponding to the amount of change in luminance detected by photoelectric conversion is input to the inverting input terminal of the comparator 336. A comparison reference voltage (Von, Vreset, or Voff) is input as a threshold voltage to the non-inverting input terminal of the comparator 336.

The switching element 332 is connected between the output terminal and the inverting input terminal of the comparator 336. The switching element 332 is brought into a conductive state (ON)/a non-conductive state (OFF) according to the operation control signal from the control unit 40. The control unit 40 executes a reset operation by causing the switching element 332 and the switching element 334 to be conductive on the basis of the event signal from the recording region 30.

The switching elements 333, 334, and 335 cause three respective paths, which are connected to the non-inverting input terminal of the comparator 336, to be conductive, according to operation control signals Son, Srs, and Soff from the control unit 40. By the operation control signal (ON control signal Son, reset control signal Srs, OFF control signal Soff) by the control unit 40, any one of the switching elements 333, 334, and 335 corresponding to each operation control signal is caused to be conductive. Therefore, the comparison reference voltage (Von, Vreset, or Voff) corresponding to the operation control signal is selectively input to the non-inverting input terminal of the comparator 336.

The comparator 336 compares the voltage signal input to the inverting input terminal with the comparison reference voltage input to the non-inverting input terminal, and outputs an event signal according to the detection result. The event signal is output from the comparator 336 and recorded in the recording region 30.

The control unit 40 performs operation control of the event detection circuit 300 in a time division manner by the ON control signal Son, the reset control signal Srs, and the OFF control signal Soff. The control unit 40 causes the switching element 333 to be conductive by using the ON control signal Son. Therefore, the comparison reference voltage Von on a positive side is input to the non-inverting input terminal of the comparator 336. The comparator 336 compares the amount of change in the input voltage signal with the comparison reference voltage Von, and outputs an on-event signal when the voltage signal exceeds the comparison reference voltage Von serving as a threshold. The on-event signal output from the comparator 336 is recorded in the recording region 30.

Furthermore, the control unit 40 executes processing of reading out the recorded on-event signal from the recording region 30.

The control unit 40 causes the switching element 335 to be conductive by using the OFF control signal Soff. Therefore, the comparison reference voltage Voff on a negative side is input to the non-inverting input terminal of the comparator 336. The comparator 336 compares the amount of change in the input voltage signal with the comparison reference voltage Voff, and outputs an off-event signal when the voltage signal falls below the comparison reference voltage Voff serving as a threshold. The off-event signal output from the comparator 336 is recorded in the recording region 30.

Furthermore, the control unit 40 executes processing of reading out the recorded off-event signal from the recording region 30.

The control unit 40 causes the switching elements 332 and 334 to be conductive by using the reset control signal Srs. Therefore, the comparison reference voltage varied by the ON control signal Son and the OFF control signal Soff in the event detection circuit 300 is reset to Vreset.

The recording region 30 includes recording units 31a, 32a, 31b, and 32b. Each of the recording units 31a, 32a, 31b, and 32b is, for example, a latch circuit that records (holds) an event signal from the comparator 336 and outputs the recorded event signal. The recording units 31a, 32a, 31b, and 32b may be semiconductor memories such as a latch circuit, an SRAM, a DRAM, and a flash memory.

The recording unit 31a is connected between the output terminal of the comparator 336 and the recording unit 32a. The recording unit 31a receives an on-event signal Eon output from the comparator 336 and records the on-event signal Eon. Furthermore, the recording unit 31a outputs the held on-event signal Eon to the recording unit 32a.

The recording unit 32a is connected between the output terminal of the recording unit 31a and a readout line VSLa. The recording unit 32a receives the on-event signal Eon output from the recording unit 31a and records the on-event signal Eon. Furthermore, the recording unit 32a outputs the held on-event signal Eon to the readout line VSLa.

As described above, the plurality of recording units 31a and 32a is connected in series between the output terminal of the comparator 336 and the readout line VSLa. The recording units 31a and 32a are provided to read out the on-event signal Eon to the readout line VSLa.

The recording unit 31b is connected between the output terminal of the comparator 336 and the recording unit 32b. The recording unit 31b receives an off-event signal Eoff output from the comparator 336 and records the off-event signal Eoff. Furthermore, the recording unit 31b outputs the held off-event signal Eoff to the recording unit 32b.

The recording unit 32b is connected between the output terminal of the recording unit 31b and a readout line VSLb. The recording unit 32b receives the off-event signal Eoff output from the recording unit 31b, and records the off-event signal Eoff. Furthermore, the recording unit 32b outputs the held off-event signal Eoff to the readout line VSLb.

As described above, the plurality of recording units 31b and 32b is connected in series between the output terminal of the comparator 336 and the readout line VSLb. The recording units 31b and 32b are provided to read out the off-event signal Eoff to the readout line VSLb.

The control unit 40 is connected between each output terminal of the recording units 31a and 31b and the switching element 332. The control unit 40 receives the event signals Eon and Eoff held and output by the recording units 31a and 31b, and performs on/off control of the switching element 332 according to the logic of the event signals Eon and Eoff. Furthermore, the control unit 40 reads out the event signals Eon and Eoff from the recording units 32a and 32b to the readout lines VSLa and VSLb.

The readout lines VSLa and VSLb are connected to output terminals of the recording units 32a and 32b, respectively. The readout lines VSLa and VSLb transmit the event signals Eon and Eoff read out from the recording units 32a and 32b, respectively, to the signal processing circuit 240 in FIG. 5.

Next, the operation of the photodetection element 1 according to the present embodiment will be described.

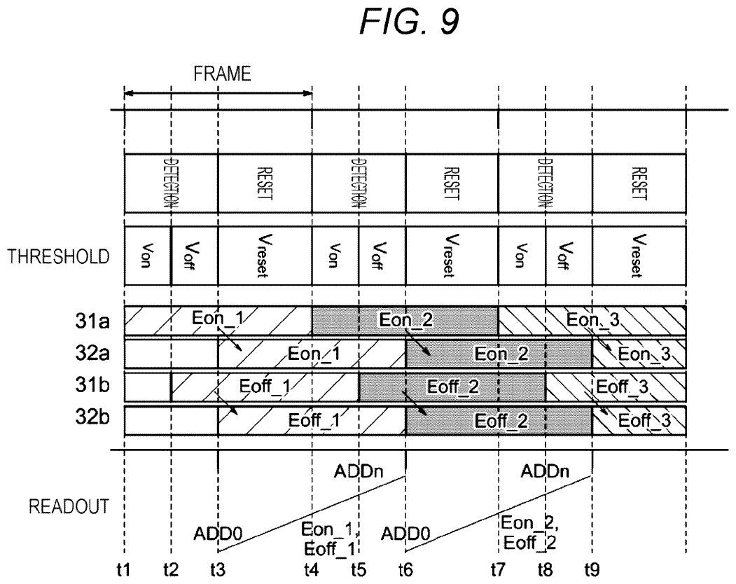

FIG. 9 is a timing diagram illustrating an operation example of the photodetection element 1 according to the first embodiment.

In one frame, an event signal detection operation and a reset operation are executed. In the detection operation of the event signal, the control unit 40 executes the detection operation of the on-event signal Eon with the comparison reference voltage as Von and the detection operation of the off-event signal Eoff with the comparison reference voltage as Voff. In the reset operation, the control unit 40 turns on the switching elements 332 and 334, returns the comparison reference voltage to Vreset, and equalizes the potentials of the inverting input terminal and the output terminal of the comparator 336.

First, from t1 to t2, the detection operation of the on-event signal Eon is executed. In the detection operation of the on-event signal Eon, the control unit 40 turns on the switching element 333 in FIG. 8 and inputs the comparison reference voltage Von as a threshold to the non-inverting input terminal of the comparator 336.

The comparator 336 compares the voltage signal input to the inverting input terminal with the comparison reference voltage Von.

In a case where the voltage signal exceeds the comparison reference voltage Von, the comparator 336 raises (activates) the on-event signal Eon to a high level voltage. In a case where the voltage signal does not exceed the comparison reference voltage Von, the comparator 336 maintains (does not activate) the on-event signal Eon at a low level voltage. The on-event signal Eon is recorded in the recording unit 31a. The on-event signal recorded at this time is referred to as Eon_1.

Next, from t2 to t3, the detection operation of the off-event signal Eoff is executed. In the detection operation of the off-event signal Eoff, the control unit 40 turns on the switching element 335 in FIG. 8 and inputs the comparison reference voltage Voff as a threshold to the non-inverting input terminal of the comparator 336. The comparator 336 compares the voltage signal input to the inverting input terminal with the comparison reference voltage Voff.

In a case where the voltage signal falls below the comparison reference voltage Voff, the comparator 336 raises (activates) the off-event signal Eoff to a high level voltage. In a case where the voltage signal does not fall below the comparison reference voltage Voff, the comparator 336 maintains (does not activate) the off-event signal Eoff at a low level voltage. The off-event signal Eoff is recorded in the recording unit 31b. The off-event signal recorded at this time is referred to as Eoff_1.

Next, from t3 to t4, the reset operation is executed. In the reset operation, the control unit 40 turns on or keeps off the switching elements 332 and 334 in FIG. 8, on the basis of the logic of the on-event signal Eon_1 and the off-event signal Eoff_1 recorded in the recording units 31a and 31b. For example, in a case where either the on-event signal Eon_1 or the off-event signal Eoff_1 is activated and rises to a high level voltage, the control unit 40 turns on the switching elements 332 and 334 of the pixel. Therefore, the comparison reference voltage Vreset is input to the non-inverting input terminal of the comparator 336, and the inverting input terminal and the output terminal of the comparator 336 are short-circuited via the switching element. 332. Therefore, the inverting input terminal and the output terminal of the comparator 336 are reset to the comparison reference voltage Vreset. The comparison reference voltage Vreset is a voltage between the comparison reference voltage Von and the comparison reference voltage Voff, and is preferably an intermediate voltage thereof. On the other hand, for example, in a case where neither the on-event signal Eon_1 nor the off-event signal Eoff_1 is activated and both are at a low level voltage, the control unit 40 maintains the switching elements 332 and 334 of the pixel in the off state. This is because no event occurs in the pixel (that is, the change in the light reception amount is small), and the signal voltage from the light receiving unit 221 does not exceed the comparison reference voltage Von and does not fall below the comparison reference voltage Voff, so that the reset operation is unnecessary.

Furthermore, during the reset operation period from t3 to t4, the on-event signal Eon_1 recorded in the recording unit 31a is transferred to the recording unit 32a and recorded in the recording unit 32a. The recording unit 32a records the on-event signal Eon_1 from the recording unit 31a.

On the other hand, during the reset operation period from t3 to t4, the off-event signal Eoff_1 recorded in the recording unit 31b is transferred to the recording unit 32b and recorded in the recording unit 32b. The recording unit 32b records the off-event signal Eoff_1 from the recording unit 31b.

Moreover, during the reset operation period, the recording unit 32a starts outputting the on-event signal Eon_1 to the readout line VSLa. The recording unit 32b starts outputting the off-event signal Eoff_1 to the readout line VSLb. That is, in the reset operation period, the on-event signal Eon_1 is temporarily transferred from the recording unit 31a to the recording unit 32a, and is sequentially read out from the recording unit 32a to the readout line VSLa. During the reset operation period, the off-event signal Eoff_1 is temporarily transferred from the recording unit 31b to the recording unit 32b, and is sequentially read out from the recording unit 32b to the readout line VSLb. The on-event signal Eon_1 and the off-event signal Eoff_1 are read out, for example, in the order of row addresses ADDO to ADDn (n is a positive integer). The on-event signal Eon_1 and off-event signal Eoff_1 which are read out are transmitted to the signal processing circuit 240 via the readout lines VSLa and VSLb.

Note that in a case where the voltage signal exceeds the comparison reference voltage Von, in the reset period, the control unit 40 increases the comparison reference voltage Von by a predetermined value for the next frame. In a case where the voltage signal does not exceed the comparison reference voltage Von, the control unit 40 does not change the comparison reference voltage Von. In a case where the voltage signal falls below the comparison reference voltage Voff, in the reset period, the control unit 40 decreases the comparison reference voltage Voff by a predetermined value for the next frame. In a case where the voltage signal falls below the comparison reference voltage Voff, the control unit 40 does not change the comparison reference voltage Voff.

At t4, the next frame is started. From t4 to t5, the detection operation of the on-event signal Eon is performed similarly to the operation from t1 to t2, and from t5 to t6, the detection operation of the off-event signal Eoff is performed similarly to the operation from t2 to t3. Therefore, the recording unit 31a records an on-event signal Eon_2, and the recording unit 31b records an off-event signal Eoff_2. At this time, the on-event signal Eon_1 and the off-event signal Eoff_1 are being read out from the recording units 32a and 32b to the readout lines VSLa and VSLb, respectively. However, the on-event signal Eon_1 is recorded and held in the recording unit 32a, and the off-event signal Eoff_1 is recorded and held in the recording unit 32b. Thus, even when the recording unit 31a is updated with the on-event signal Eon_2 and the recording unit 31b is updated with the off-event signal Eoff_2, there is no problem in the readout operation of the on-event signal Eon_1 and the off-event signal Eoff_1.

As described above, since the readout operation of the event signals Eon and Eoff from the recording units 32a and 32b to the readout lines VSLa and VSLb is executed for every row address, it takes a certain time. However, in the photodetection element 1 according to the present embodiment, in addition to the recording units 31a and 31b, the recording units 32a and 32b are also provided, corresponding to the recording units 31a and 31b, at the subsequent stage of the recording units 31a and 31b, respectively. Thus, the event signals Eon_1 and Eoff_1 recorded in the recording units 31a and 31b are transferred to the recording units 32a and 32b in advance, allowing the reset operation and the next frame to be executed while the event signals Eon_1 and Eoff_1 are read out from the recording units 32a and 32b. Therefore, even during the readout of the event signals Eon_1 and Eoff_1, the reset operation can be executed, and the next event signals Eon_2 and Eoff_2 can be recorded in the recording units 31a and 31b, respectively.

Note that, since the readout operation of the event signals Eon_1 and Eoff_1 overlaps with the reset operation, it is necessary to end the readout operation before the reset operation of the next frame is started. This is because, in the reset operation of the next frame, the readout operation of the event signals Eon_2 and Eoff_2 is started.

That is, from t6 to t7, the reset operation is performed similarly to the operation from t3 to t4. At this time, the event signals Eon_2 and Eoff_2 are read out from the recording units 32a and 32b to the readout lines VSLa and VSLb, respectively.

Thereafter, after t7, the next frame is further started.

The photodetection element 1 according to the present embodiment is provided with a plurality of 31a and 32a to record the on-event signal Eon, and is provided with a plurality of 31b and 32 b to record the off-event signal Eoff. Therefore, the event signals Eon and Eoff recorded in the recording units 31a and 31b are transferred to the recording units 32a and 32b in advance, allowing the reset operation and the next frame to be executed while the event signals Eon and Eoff are read out from the recording units 32a and 32b. Therefore, even during the reset operation period, it is possible to read out the event signals Eon and Eoff.

Furthermore, even during the readout period of the event signals Eon and Eoff, the next event signals can be recorded in the recording units 31a and 31b, respectively. As a result, the frame can be shortened, and the detection cycle of the event signal can be shortened.

### Second Embodiment

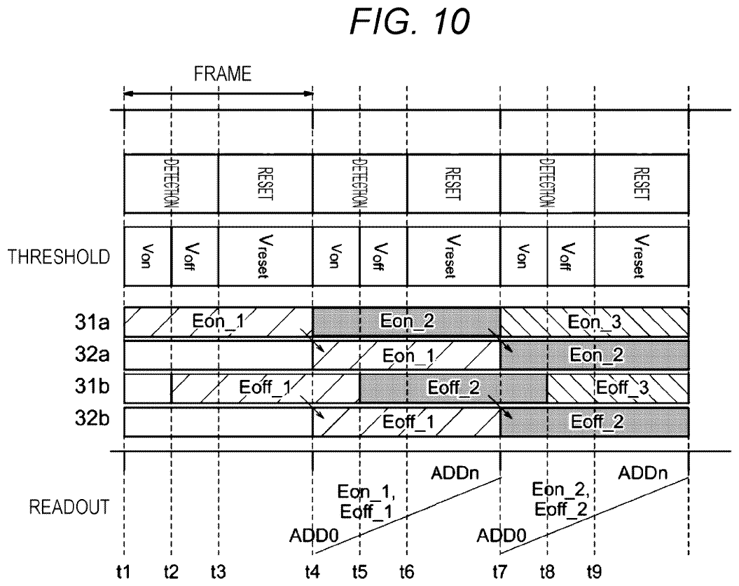

FIG. 10 is a timing diagram illustrating an operation example of the photodetection element 1 according to a second embodiment. The configuration of the photodetection element 1 of the second embodiment may be the same as the configuration of the first embodiment. The second embodiment is different from the first embodiment in that each of the transfer operations of the event signals Eon and off from the recording units 31a and 31b to the recording units 32a and 32b is started from the next frame.

First, the operation from t1 to t3 are the same as the operation from t1 to t3 in FIG. 9. Therefore, the detection operation of the on-event signal Eon and the off-event signal Eoff is executed. The on-event signal Eon_1 is recorded in the recording unit 31a. The off-event signal Eoff_1 is recorded in the recording unit 31b.

Next, the reset operation from t3 to t4 is the same as the reset operation from t3 to t4 in FIG. 9. However, during the reset operation period from t3 to t4, the on-event signal Eon_1 recorded in the recording unit 31a is not yet transferred to the recording unit 32a. The off-event signal Eoff_1 recorded in the recording unit 31b is not yet transferred to the recording unit 32b. Therefore, during the reset operation period, the readout operation of the on-event signal Eon_1 and the off-event signal Eoff_1 is not started yet.

From t4 to t7, the next frame is executed. At this time, the on-event signal Eon_1 recorded in the recording unit 31a is transferred to the recording unit 32a, and the off-event signal Eoff_1 recorded in the recording unit 31b is transferred to the recording unit 32b. Furthermore, the recording unit 32a starts outputting the on-event signal Eon_1 to the readout line VSLa. The recording unit 32b starts outputting the off-event signal Eoff_1 to the readout line VSLb. That is, the on-event signal Eon_1 is temporarily transferred from the recording unit 31a to the recording unit 32a in the next frame, and is sequentially read out from the recording unit 32a to the readout line VSLa. In the next frame, the off-event signal Eoff_1 is temporarily transferred from the recording unit 31b to the recording unit 32b, and is sequentially read out from the recording unit 32b to the readout line VSLb.

When the next frame is started, from t4 to t5, the detection operation of the on-event signal Eon is performed similarly to the operation from t1 to t2, and from t5 to t6, the detection operation of the off-event signal Eoff is performed similarly to the operation from t2 to t3. Therefore, the recording unit 31a records an on-event signal Eon_2, and the recording unit 31b records an off-event signal Eoff_2. At this time, the on-event signal Eon_1 and the off-event signal Eoff_1 are being read out from the recording units 32a and 32b to the readout lines VSLa and VSLb, respectively. However, the on-event signal Eon_1 is recorded and held in the recording unit 32a, and the off-event signal Eoff_1 is recorded and held in the recording unit 32b. Thus, even when the recording unit 31a is updated with the on-event signal Eon_2 and the recording unit 31b is updated with the off-event signal Eoff_2, there is no problem in the readout operation of the on-event signal Eon_1 and the off-event signal Eoff_1.

Note that, in the second embodiment, the readout operation of the event signals Eon_1 and Eoff_1 needs to be ended before the detection operation of the next frame is started. This is because, in the detection operation of the next frame, the readout operation of the event signals Eon_2 and Eoff_2 is started.

That is, from t7 to t9, the detection operation is performed similarly to the operation from t4 to t6. At this time, the event signals Eon_2 and Eoff_2 are read out from the recording units 32a and 32b to the readout lines VSLa and VSLb, respectively.

Thereafter, after to, the reset operation of the next frame is further started.

Also in the operation according to the second embodiment, the event signals Eon and Eoff recorded in the recording units 31a and 31b are transferred to the recording units 32a and 32b in advance, and the next frame can be executed while the event signals Eon and Eoff are read out from the recording units 32a and 32b. Therefore, the frame can be shortened, and the detection cycle of the event signal can be shortened.

### Third Embodiment

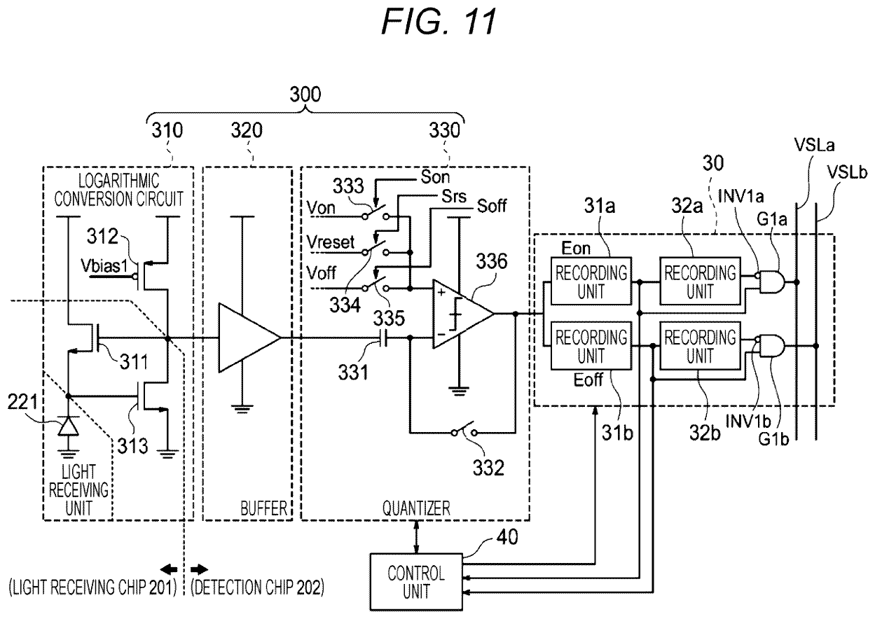

FIG. 11 is a circuit diagram illustrating an example of the configuration of the event detection circuit 300, the recording region 30, and the control unit 40 according to a third embodiment. The recording region 30 of the third embodiment includes inverters INV1a and INVb and logic gates G1a and G1b.

The inverter INV1a is connected between the output terminal of the recording unit 32a and the logic gate G1a. The inverter INV1a outputs the inverted signal of the output signal of the recording unit 32a to the logic gate G1a.

Two input terminals of the logic gate G1a are connected to the output terminal of the inverter INV1a and the output terminal of the recording unit 31a, respectively. The output terminal of the logic gate G1a is connected to the readout line VSLa. The logic gate G1a outputs, to a readout line VSL1a, a logical AND of the output signal of the recording unit 31a and the output signal of the inverter INV1a.

The inverter INV1b is connected between the output terminal of the recording unit 32b and the logic gate G1b. The inverter INV1b outputs the inverted signal of the output signal of the recording unit 32b to the logic gate G1b.

Two input terminals of the logic gate G1b are connected to the output terminal of the inverter INV1b and the output terminal of the recording unit 31b, respectively. The output terminal of the logic gate G1b is connected to the readout line VSLb. The logic gate G1b outputs, to a readout line VSL1b, a logical AND of the output signal of the recording unit 31b and the output signal of the inverter INV1b.

The other configurations of the third embodiment may be similar to the corresponding configurations of the first embodiment.

Note that in the third embodiment, the inverters INV1a and INV1b are connected to the output terminals of the recording units 32a and 32b. However, the inverters INV1a and INV1b may be connected to the output terminals of the recording units 32a and 32b, respectively, instead of the output terminals of recording units 31a and 31b.

In this case, the logic gate G1a outputs, to the readout line VSL1a, a logical AND of the inverted signal of the output signal of the recording unit 31a and the output signal of the recording unit 32a. The logic gate G1b outputs, to the readout line VSL1b, a logical AND of the inverted signal of the output signal of the recording unit 31b and the output signal of the recording unit 32b.

Next, the operation of the photodetection element 1 according to the third embodiment will be described.

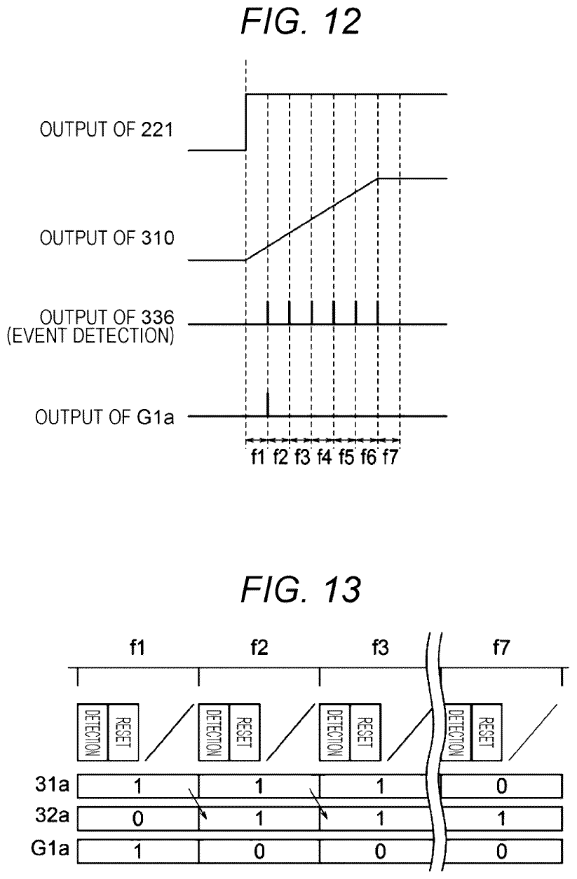

FIGS. 12 and 13 are timing diagrams illustrating an operation example of the photodetection element 1 according to the third embodiment. The detection operation, the reset operation, and the readout operation of the photodetection element 1 of the third embodiment may be basically the same as the respective operations illustrated in FIG. 10. However, in the third embodiment, in one frame, the detection operation, the reset operation, and the readout operation are executed in one frame, and the readout operation does not overlap the detection operation or the reset operation.

Furthermore, the readout signals read out to the readout lines VSLa and VSLb are the output signals of the logic gates G1a and G1b, respectively. Thus, the readout signal read out to the readout line VSLa is a logical operation result of the output signals of the recording unit 1a and the recording unit 2a, and the readout signal read out to the readout line VSLb is a logical operation result of the output signals of the recording unit 1b and the recording unit 2b.

In this case, for example, when the light receiving unit 221 in FIG. 8 detects a change in the amount of received light, the output voltage of the logarithmic conversion circuit 310 may gradually and largely change over a plurality of frames f1 to f6. In such a case, a plurality of event signals may be detected for one event. such a plurality of event signals detected for one event is referred to as a tail event. In order to detect such a tail event as one event signal, the photodetection element 1 according to the third embodiment includes the logic gates G1a and G1b in the recording region 30.

Note that, hereinafter, it is assumed that the recording units 31a, 32a, 31b, and 32b record logic “0” in a state where the on-event signal or the off-event signal does not rise, and that the recording units 31a, 32a, 31b, and 32b record logic “1” when the on-event signal or the off-event signal rises.

For example, as illustrated in FIG. 12, the output of the light receiving unit 221 rises, and the output of the logarithmic conversion circuit 310 gradually rises.

In the first frame f1, when the voltage signal input to the comparator 336 exceeds the comparison reference voltage Von, the output (on-event signal) of the comparator 336 rises, and the recording unit 31a records “1” as illustrated in FIG. 13. That is, the event signal Eon_1 in FIG. 10 becomes “1”. At this time, as illustrated in FIG. 13, the recording unit 32a is still “0”, and thus the logic gate G1a outputs “1”.

In the next frame f2, the comparison reference voltage Von is updated to a threshold voltage higher than the comparison reference voltage in the frame f1.

Furthermore, as illustrated in FIG. 13, the on-event signal “1” of the recording unit 31a is transferred to the recording unit 32a, and the recording unit 32a records “1”. Then, when the voltage signal input to the comparator 336 exceeds the updated comparison reference voltage Von, the output (on-event signal) of the comparator 336 rises, and the recording unit 31a records “1” as illustrated in FIG. 13. Thus, both the recording units 31a and 32a output “1”, and the logic gate G1a outputs “0”.

The frames f3 to f6 repeat an operation similar to that in the frame f2. Thus, in the frames f3 to f6, the logic gate G1a outputs “0”. At this time, the comparison reference voltage Von is updated to a threshold voltage higher than the comparison reference voltage in the immediately preceding frame.

In the frame f7, the comparison reference voltage Von does not exceed the comparison reference voltage.

Thus, as illustrated in FIG. 13, the recording unit 32a records “0”. Thus, the recording units 31a and 32a output “0” and “1”, respectively, and the logic gate G1a outputs “0”. Thereafter, unless the signal voltage exceeds the comparison reference voltage Von, the logic gate G1a outputs “0”.

That is, in the frames f1 to f7 . . . ; the logic gate G1a outputs “1”, “0”, “0”, “0”, “0”, “0”, “0” . . . , respectively.

As described above, even in a case where one event includes a tail event over a plurality of frames, the photodetection element 1 according to the third embodiment can detect the tail event as one event signal as long as the voltage signal continuously exceeds the updated comparison reference voltage Von.

In the above-described specific example, the on-event signal has been described. However, the off-event signal is also similar. In this case, when the voltage signal input to the comparator 336 falls below the comparison reference voltage Voff, the output (off-event signal) of the comparator 336 rises, and the recording unit 31b records “1”. At this time, the recording unit 32b is still “0”, and thus the logic gate G1b outputs “1”.

In the next frame, the comparison reference voltage Voff is updated to a threshold voltage lower than the comparison reference voltage in the immediately preceding frame. Furthermore, the off-event signal “1” of the recording unit 31b is transferred to the recording unit 32b, and the recording unit 32b records “1”. Then, when the voltage signal input to the comparator 336 falls below the updated comparison reference voltage Voff, the output (off-event signal) of the comparator 336 rises, and the recording unit 31b records “1”. Thus, both the recording units 31b and 32b output “1”, and the logic gate G1b outputs “0”.

In the subsequent frame, as long as the voltage signal continuously falls below the updated comparison reference voltage Voff, the logic gate G1b outputs “0”.

At this time, the comparison reference voltage Voff is updated to a threshold voltage lower than the comparison reference voltage in the immediately preceding frame.

When the signal voltage no longer falls below the comparison reference voltage Voff, the recording unit 32b records “0”. Thus, the recording units 31a and 32a output “0” and “1”, respectively, and the logic gate G1a outputs “0”. Thereafter, unless the signal voltage falls below the comparison reference voltage Voff, the logic gate G1b outputs “0”.

As described above, even in a case where one event includes a tail event over a plurality of frames, the tail event can be detected as one event signal.

The other operations of the third embodiment may be similar to the operations of the second embodiment.

Therefore, the third embodiment can obtain effects similar to those of the second embodiment.

### Fourth Embodiment

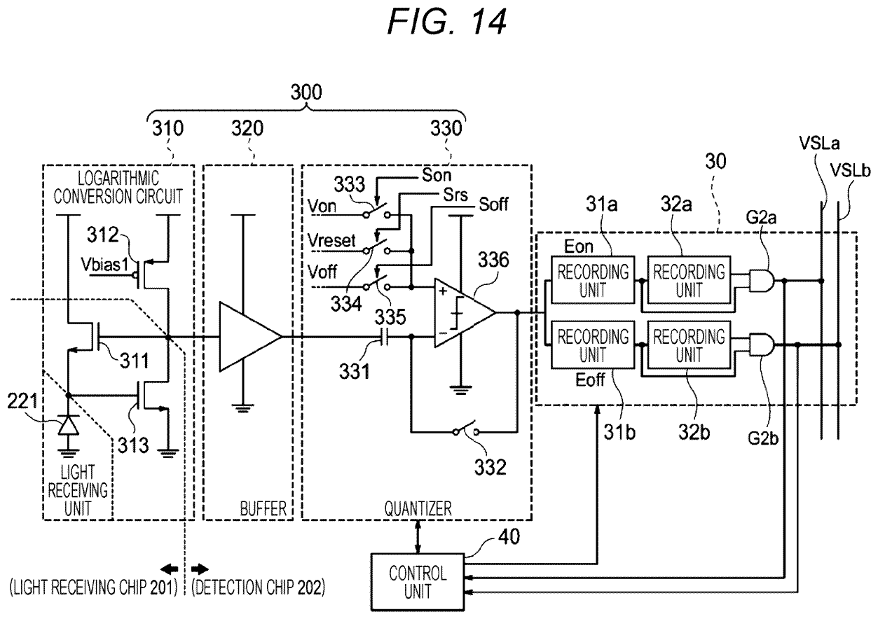

FIG. 14 is a circuit diagram illustrating an example of the configuration of the event detection circuit. 300, the recording region 30, and the control unit 40 according to a fourth embodiment. The recording region 30 of the fourth embodiment includes logic gates G2a and G2b.

Two input terminals of the logic gate G2a are connected to the output terminal of the recording unit 31a and the output terminal of the recording unit 32a, respectively. The output terminal of the logic gate G2a is connected to the readout line VSLa. The logic gate G2a outputs, to the readout line VSL1a and the control unit 40, a logical AND of the output signal of the recording unit 31a and the output signal of the recording unit 32a.

Two input terminals of the logic gate G2b are connected to the output terminal of the recording unit 31b and the output terminal of the recording unit 32b, respectively. The output terminal of the logic gate G2b is connected to the readout line VSLb. The logic gate G2b outputs, to the readout line VSL1b and the control unit 40, a logical AND of the output signal of the recording unit 31b and the output signal of the recording unit 32b.

The output terminals of the logic gates G2a and G2b are connected to the control unit 40. The control unit 40 controls the switching element 332 on the basis of the output signal of each of the logic gates G2a and G2b.

Therefore, the control unit 40 executes the reset operation when the on-event signal rises continuously twice. Alternatively, the control unit 40 executes the reset operation when the off-event signal rises continuously twice.

The other configurations of the fourth embodiment may be similar to the corresponding configurations of the first embodiment.

Next, the operation of the photodetection element 1 according to the fourth embodiment will be described.

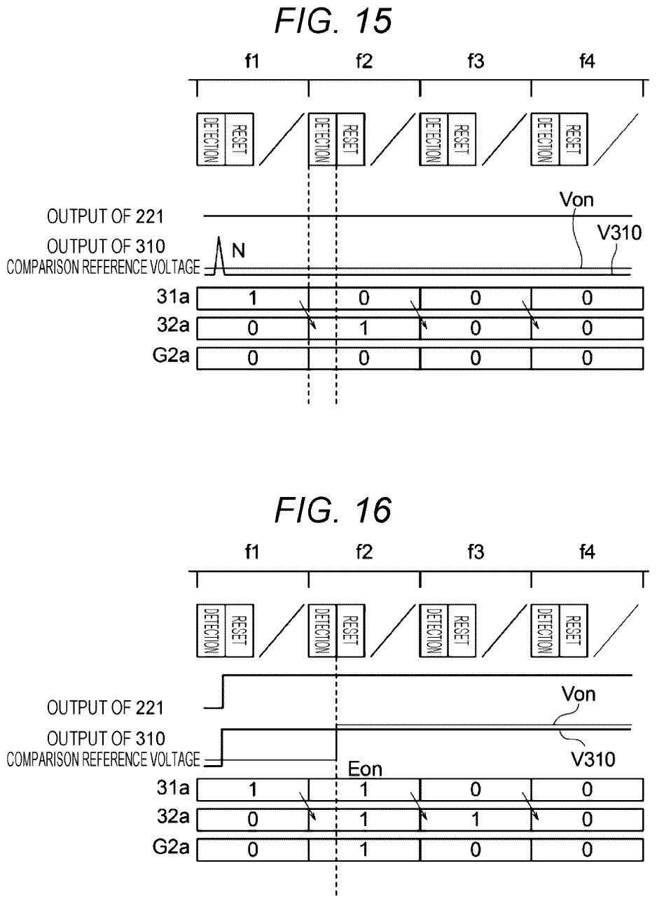

FIGS. 15 and 16 are timing diagrams illustrating an operation example of the photodetection element 1 according to the fourth embodiment. The detection operation, the reset operation, and the readout operation of the photodetection element 1 of the fourth embodiment may be basically the same as the respective operations illustrated in FIG. 10. However, in the fourth embodiment, in one frame, the detection operation, the reset operation, and the readout operation are executed in one frame, and the readout operation does not overlap the detection operation or the reset operation.

Furthermore, the signals to be output to the control unit 40 are the output signals of the logic gates G2a and G2b. Thus, the control unit 40 executes the reset operation using, as the reset signal, the logical AND of the output signals of the recording unit 1a and the recording unit 2a or the logical AND of the output signals of the recording unit 1b and the recording unit. 2b. That is, when the events occur continuously, the control unit 40 executes the reset operation.

Note that, hereinafter, it is assumed that the recording units 31a, 32a, 31b, and 32b record logic “0” in a state where the on-event signal or the off-event signal does not rise, and that the recording units 31a, 32a, 31b, and 32b record logic “1” when the on-event signal or the off-event signal rises continuously.

For example, in FIG. 15, when the output voltage of the logarithmic conversion circuit 310 is denoted as V310, the comparison reference voltage Von is higher than output voltage V310 by the threshold voltage in a state where there is no event.

Here, in the frame f1, in a case where noise N occurs, the output voltage V310 may instantaneously exceed the comparison reference voltage Von. In this case, since the output voltage V310 exceeds the comparison reference voltage Von, the recording unit 31a records “1”. However, in the next frame f2, the output voltage V310 does not exceed the comparison reference voltage Von. Thus, although “1” of the recording unit 31a is transferred to the recording unit 32a, “0” is recorded in the recording unit 31a. since both the recording units 31a and 32a do not become “1”, the logic gate G2a maintains “0”. In this case, the control unit 40 does not execute the reset operation in the reset period. As described above, even when the output voltage V310 exceeds the comparison reference voltage Von in only one frame, the control unit 40 does not execute the reset operation in the reset period.

In the frames f3 and f4, no noise or event occurs, and the output voltage V310 does not exceed the comparison reference voltage Von. Thus, the recording units 31a and 32a record “0”, and the logic gate G2a Outputs “0”.

For example, in FIG. 16, in frame f1, in a case where an event occurs, the output voltage V310 exceeds the comparison reference voltage Von. In this case, since the output voltage V310 exceeds the comparison reference voltage Von, the recording unit 31a records “1”. However, in the frame f1, the logic gate G2a still maintains “0”, and thus the control unit 40 does not execute the reset operation during the reset period of the frame f1.

In the next frame f2, an event occurs and the output voltage V310 remains above the comparison reference voltage Von. Thus, “1” of the recording unit. 31a is transferred to the recording unit 32a, and “1” is recorded in the recording unit 31a. Since both the recording units 31a and 32a become “1”, the logic gate G2a outputs “1”. In this case, the control unit 40 executes the reset operation in the reset period, and the comparison reference voltage Von is updated. As described above, in a case where the output voltage V310 exceeds the comparison reference voltage Von in two consecutive frames, the control unit 40 executes the reset operation in the reset period.

In the frames f3 and f4, no event occurs, and the output voltage V310 does not exceed the comparison reference voltage Von. Thus, the recording unit 31a records “0”, and the logic gate G2a outputs “0”.

In the above-described specific example, the on-event signal has been described. However, the off-event signal is also similar. Detection of the off-event signal can be readily understood from the above description of the on-event signal. Thus, the description of the off-event signal according to the fourth embodiment is omitted here.

In a case where the logic gates G2a and G2b are not provided, noise that instantaneously rises in one frame is determined as occurrence of an event, and the control unit 40 executes the reset operation to update the comparison reference voltage Von or Voff.

On the other hand, the photodetection element 1 according to the fourth embodiment includes the logic gates G2a and G2b, and the logic gates G2a and G2b output the logical AND of the output signals of the recording units 31a and 32a or the logical AND of the output signals of the recording units 31b and 32b. Therefore, when an on-event signal or an off-event signal is detected in two or more consecutive frames, the logic gates G2a and G2b can raise the output signal, and the control unit 40 can execute the reset operation. As a result, the photodetection element 1 can suppress erroneous determination of noise as an event, and can reliably detect an event.

The other operations of the fourth embodiment may be similar to the operations of the second embodiment.

Therefore, the fourth embodiment can obtain effects similar to those of the second embodiment.

### Fifth Embodiment

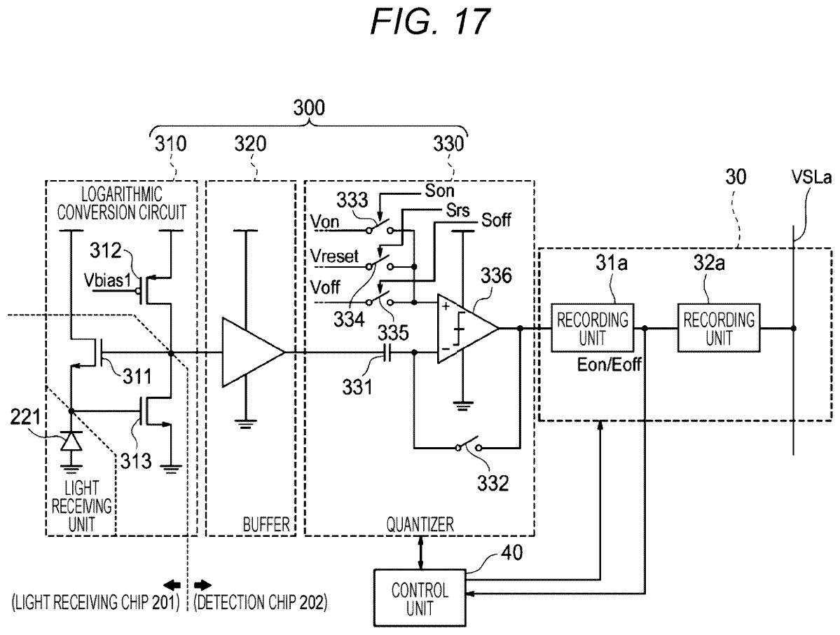

FIG. 17 is a circuit diagram illustrating an example of the configuration of the event detection circuit 300, the recording region 30, and the control unit 40 according to a fifth embodiment. The recording region 30 of the fifth embodiment includes two recording units 31a and 32a connected in series between the output. terminal of the comparator 336 and the readout line VSLa. However, the recording units 31b and 32b and the readout line VSLb are omitted.

On the other hand, in this case, the recording units 31a and 32a alternately record the on-event signal Eon and the off-event signal Eoff. Furthermore, the recording units 31a and 32a alternately read out the on-event signal Eon and the off-event signal Eoff via the readout line VSLa. Thus, the readout operation of each pixel is executed twice for each frame.

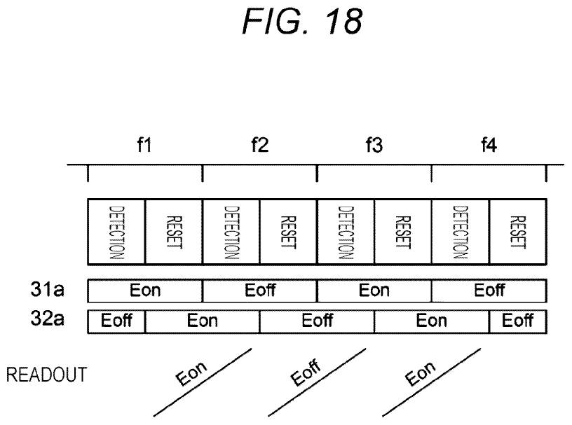

FIG. 18 is a timing diagram illustrating an operation example of the photodetection element 1 according to the fifth embodiment. The detection operation and the reset operation are basically the same as those of the first embodiment. However, in the photodetection element 1 according to the fifth embodiment, the recording units 31a and 32a alternately detect the on-event signal Eon and the off-event signal Eoff.

For example, in the detection operation of the frame f1, the control unit 40 turns on the switching element 333. In the detection operation of the frame f1, the event detection circuit 300 detects the on-event signal Eon by using the comparison reference voltage Von, and the recording unit 31a records the on-event signal Eon. The on-event signal Eon of the recording unit 31a is transferred to the recording unit 32a. In the reset operation of the frame f1 and the detection operation of the next frame f2, the on-event signal Eon of the recording unit 32a is read out to the readout line VSLa.

In the detection operation of the next frame f2, the control unit 40 turns on the switching element 335. In the detection operation of the frame f2, the event detection circuit 300 detects the off-event signal Eoff by using the comparison reference voltage Voff, and the recording units 31a and 32a record the off-event signal Eoff. The off-event signal Eoff of the recording unit 31a is transferred to the recording unit 32a. In the reset operation of the frame f2 and the detection operation of the next frame f3, the off-event signal Eoff of the recording unit 32a is read out to the readout line VSLa.

As described above, the recording units 31a and 32a alternately record and alternately read out the on-event signal Eon and the off-event signal Eoff. That is, in the reset operation or the detection operation of the next frame, the recording unit 32a alternately records the event signal Eon or Eoff from the recording unit 31a, and alternately outputs the event signal Eon or Eoff to the readout line VSLa.

The other operations of the fifth embodiment may be similar to the operations of the first embodiment.

According to the fifth embodiment, the recording units 31b and 32b and the readout line VSLb are omitted, and thus the circuit scale and the layout area of the photodetection element 1 are reduced. Furthermore, according to the fifth embodiment, in the reset operation and the detection operation, the readout operation of the event signal Eon or Eoff can be redundantly executed. Thus, the fifth embodiment can obtain effects similar to those of the first embodiment.

### Sixth Embodiment

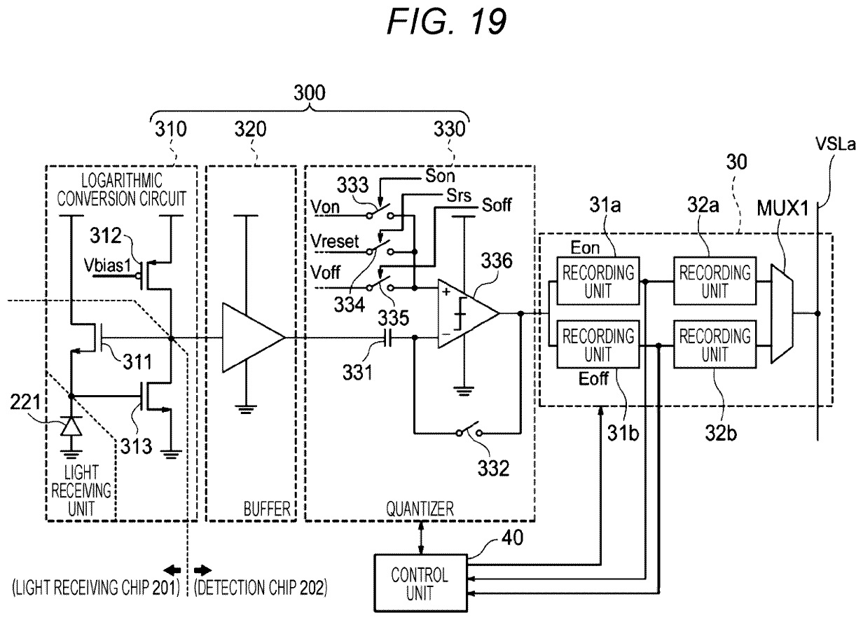

FIG. 19 is a circuit diagram illustrating an example of the configuration of the event detection circuit 300, the recording region 30, and the control unit 40 according to a sixth embodiment. The recording region 30 of the sixth embodiment includes a multiplexer MUXI connected between the output terminals of the recording units 32a and 32b and the readout line VSLa. The readout line VSLa is connected to the output terminal of the multiplexer MUXI. The readout line VSLb is omitted.

The multiplexer MUXI includes a switching element such as a MOS transistor, and is configured to selectively connect the output terminal of any one of the recording units 32a and 32b to the readout line VSLa. The control unit 40 controls the switching element of the multiplexer MUX1.

On the other hand, in this case, the multiplexer MUXI alternately reads out the event signals Eon or Eoff recorded in the recording units 32a and 32b to the readout line VSLa. Thus, the readout operation of each pixel is executed twice for every address in each frame.

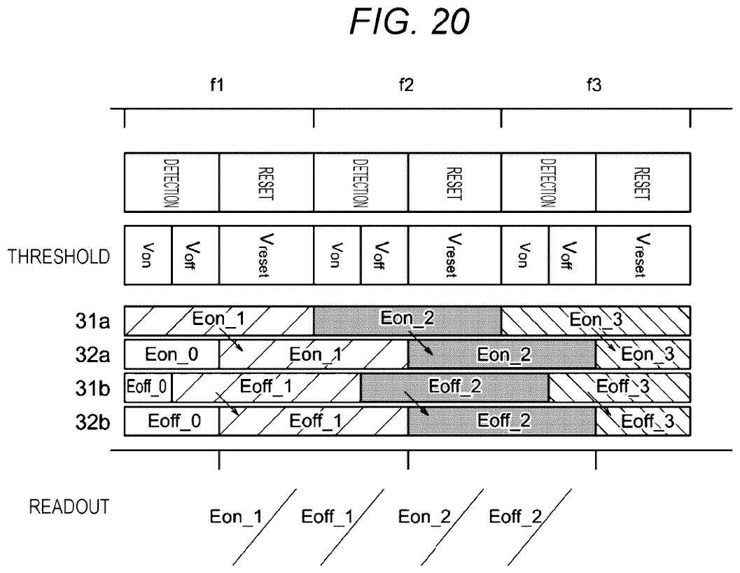

FIG. 20 is a timing diagram illustrating an operation example of the photodetection element 1 according to the sixth embodiment. The detection operation and the reset operation are basically the same as those of the first embodiment. However, according to the sixth embodiment, the multiplexer MUXI alternately reads out the on-event signal Eon of the recording unit 32a and the off-event signal Eoff of the recording unit 32b to the readout line VSLa.

For example, in the detection operation of the frame f1, the event detection circuit 300 executes the detection operation and the reset operation similarly to the first embodiment. The recording units 31a and 31b record the detected event signals Eon_1 and Eoff_1, respectively, and transfer the event signals Eon_1 and Eoff_1 to the recording units 32a and 32b, respectively, at the start of the reset operation.

The multiplexer MUX1 connects the output terminal of the recording unit 32a to the readout line VSLa, and reads out the on-event signal Eon_1 of the recording unit 32a to the readout line VSLa. Next, the multiplexer MUX1 connects the output terminal of the recording unit 32b to the readout line VSLa, and reads the off-event signal Eoff_1 of the recording unit 32b to the readout line VSLa.

The readout operation of the on-event signal Eon_1 is executed in a manner overlapping with the reset operation of the frame f1, and the readout operation of the off-event signal Eoff_1 is executed in a manner overlapping with the detection operation of the frame f2.

In the detection operation of the next frame f2, after execution of the detection operation and the reset operation, the recording units 31a and 31b record the detected on-event signals Eon_2 and Eoff_2, respectively, and transfer the on-event signals Eon_2 and Eoff_2 to the recording units 32a and 32b, respectively, at the start of the reset operation.

The multiplexer MUXI connects the output terminal of the recording unit 32a to the readout line VSLa, and reads out the on-event signal Eon_2 of the recording unit 32a to the readout line VSLa. Next, the multiplexer MUX1 connects the output terminal of the recording unit 32b to the readout line VSLa, and reads out the off-event signal Eoff_2 of the recording unit 32b to the readout line VSLa.

The readout operation of the on-event signal Eon_2 is executed in a manner overlapping with the reset operation of the frame f2, and the readout operation of the off-event signal Eoff_2 is executed in a manner overlapping with the detection operation of the frame f3.

As described above, the control unit 40 controls the multiplexer MUX1 to alternately read out the on-event. signal Eon and the off-event signal Eoff.

The other operations of the sixth embodiment may be similar to the operations of the first embodiment.

According to the sixth embodiment, although the multiplexer MUX1 is added to each pixel, the readout line VSLb is omitted, so that the circuit scale and the layout area of the photodetection element 1 can be reduced. Furthermore, according to the sixth embodiment, in the reset operation and the detection operation, the readout operation of the event signal Eon or Eoff can be redundantly executed. Thus, the sixth embodiment can obtain effects similar to those of the first embodiment.

### Seventh Embodiment

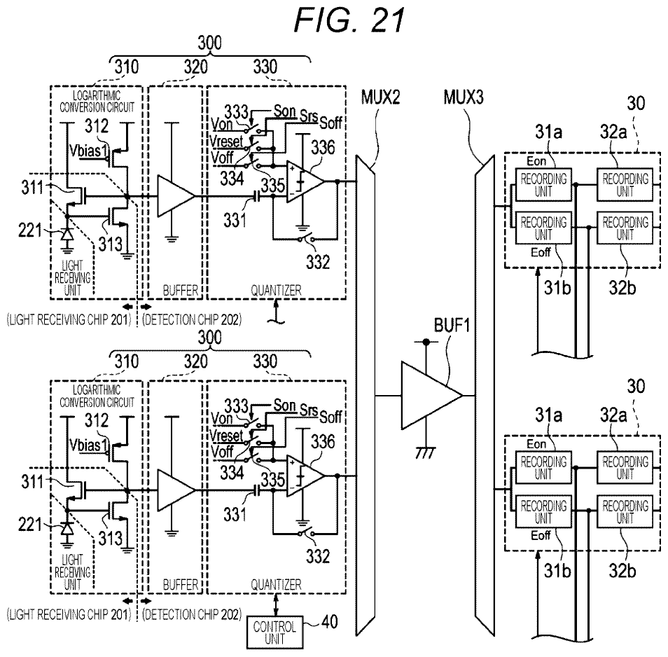

FIG. 21 is a circuit diagram illustrating an example of the configuration of the event detection circuit 300, the recording region 30, and the control unit 40 according to a seventh embodiment. A buffer BUF1 and multiplexers MUX2 and MUX3 are provided in common between a plurality of event detection circuits 300 and a plurality of recording regions 30 of the seventh embodiment.

The buffer BUF1 is provided between the output terminals of the comparators 336 of the plurality of event detection circuits 300 and the plurality of recording regions 30, and transfers the on-event signal Eon or the off-event signal Eoff from the event detection circuit 300 to the recording region 30.

The multiplexer MUX2 is provided between the input terminal of the buffer BUF1 and the output terminals of the plurality of comparators 336, and connects the output terminal of the selected comparator 336 arbitrarily selected from the plurality of comparators 336 to the input terminal of the buffer BUF1.

The multiplexer MUX3 is provided between the output terminal of the buffer BUF1 and the input terminals of the plurality of recording regions 30, and connects the input terminal of the selected recording region 30 arbitrarily selected from the plurality of recording regions 30 to the output terminal of the buffer BUF1.

The configurations of each event detection circuit 300 and each recording region 30 may be similar to those of the first embodiment. Similarly to the buffer BUF1, the control unit 40 may be provided in common for the plurality of event detection circuits 300 and the plurality of recording regions 30. The control unit 40 controls the multiplexers MUX2 and MUX3 and the buffer BUF1.

Note that the configuration of the recording region 30 may be any of the configurations of the first to sixth embodiments.

In the seventh embodiment, the multiplexer MUX2 connects the selected comparator 336 to the buffer BUF1, and transfers the on-event signal Eon or the off-event signal Eoff from the selected comparator 336 to the buffer BUF1.

The buffer BUF1 amplifies the on-event signal Eon or the off-event signal Eoff from the selected comparator 336 and transfers the signal to the multiplexer MUX3.

The multiplexer MUX3 connects the selected recording region 30 to the buffer BUF1, and transfers the on-event signal Eon or the off-event signal Eoff from the selected comparator 336 to the selected recording region 30. Therefore, the recording units 31a and 32a of the selected recording region 30 can record the on-event signal Eon, or the recording units 31b and 32b in the selected recording region 30 can record the off-event signal Eoff.

In a case where a line distance between the event detection circuit 300 and the recording region 30 is long, the buffer BUFI is required. In a case where the buffer BUF1 is provided corresponding to each connection between the plurality of event detection circuits 300 and the plurality of recording regions 30, the circuit scale of the photodetection element 1 increases.

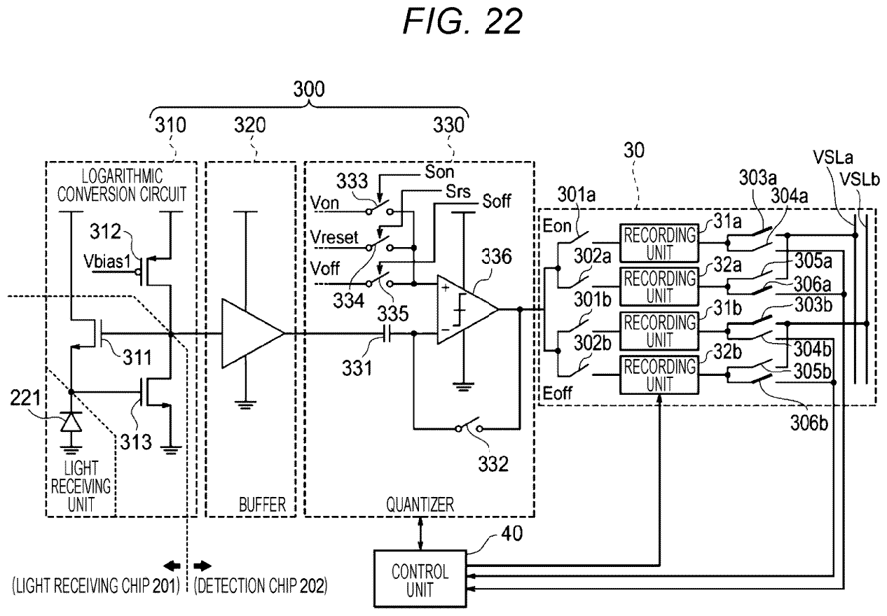

On the other hand, in the seventh embodiment, one buffer BUF1 is provided in common for the plurality of event detection circuits 300 and the plurality of recording regions 30. Therefore, it is possible to suppress an increase in the circuit scale of the photodetection element 1. Note that, in FIG. 22, one buffer BUF1 is provided in common for two event detection circuits 300 and the recording regions 30. However, one buffer BUF1 may be provided in common for three or more event detection circuits 300 and three or more recording regions 30.

The other configurations and operations of the seventh embodiment may be the same as those of any of the first to sixth embodiments. Thus, the seventh embodiment can also obtain the effect of any one of the first to sixth embodiments.

### Eighth Embodiment

FIG. 22 is a circuit diagram illustrating an example of the configuration of the event detection circuit 300, the recording region 30, and the control unit 40 according to the eighth embodiment. In the recording region 30 according to the eighth embodiment, the recording units 31a and 32a are connected in parallel to the output terminal of the comparator 336. The recording units 31b and 32b are connected in parallel to the output terminal of the comparator 336.

When one of the recording units 31a and 32a records the on-event signal Eon, the other of the recording units 31a and 32a outputs the immediately preceding on-event signal Eon to the readout line VSLa. When one of the recording units 31b and 32b records the off-event signal Eoff, the other of the recording units 31b and 32b outputs the preceding off-event signal Eoff to the readout line VSLb. As described above, the recording units 31a and 32a are used by temporally alternately switching between the recording operation and the readout operation of the on-event signal Eon. The recording units 31b and 32b are used by temporally alternately switching between the recording operation and the readout operation of the off-event signal Eoff. Therefore, the recording units 31a and 32a alternately record and output different consecutive on-event signals Eon. The recording units 31b and 32b alternately record and output different consecutive off-event signals Eoff.

In order to realize such an operation, the recording region 30 includes switching elements 301a to 306a and 301b to 306b. As the switching elements 301a to 306a and 301b to 306b, for example, MOS transistors are used.

The switching element 301a is connected between the output terminal of the comparator 336 and the input terminal of the recording unit 31a. The switching element 302a is connected between the output terminal of the comparator 336 and the input terminal of the recording unit 32a.

The switching element 303a is connected between the output terminal of the recording unit 31a and the readout line VSLa. The switching element 304a is connected between the output terminal of the recording unit 31a and the control unit 40. The switching element 305a is connected between the output terminal of the recording unit 32a and the readout line VSLa. The switching element 306a is connected between the output terminal of the recording unit 32a and the control unit 40.

The switching element 301b is connected between the output terminal of the comparator 336 and the input terminal of the recording unit 31b. The switching element 302b is connected between the output terminal of the comparator 336 and the input terminal of the recording unit 32b.

The switching element 303b is connected between the output terminal of the recording unit 31b and the readout line VSLb. The switching element 304b is connected between the output terminal of the recording unit 31b and the control unit 40. The switching element 305b is connected between the output terminal of the recording unit 32b and the readout line VSLb. The switching element 306b is connected between the output terminal of the recording unit 32b and the control unit 40.

When the switching elements 301a, 304a, and 305a are on (conductive state) and the switching elements 302a, 303a, and 306a are off (non-conductive state), the recording unit 31a records the on-event signal Eon, and the recording unit 32a outputs the immediately preceding on-event signal Eon to the readout line VSLa. Furthermore, the control unit 40 determines whether or not to perform the reset operation according to the on-event signal Eon recorded in the recording unit 31a.

When the switching elements 302a, 303a, and 306a are on and the switching elements 301a, 304a, and 305a are off, the recording unit 32a records the on-event signal Eon, and the recording unit 31a outputs the immediately preceding on-event signal Eon to the readout line VSLa. Furthermore, the control unit 40 determines whether or not to perform the reset operation according to the on-event signal Eon recorded in the recording unit 32a.

When the switching elements 301b, 304b, and 305b are on and the switching elements 302b, 303b, and 306b are off, the recording unit 31b records the off-event signal Eoff, and the recording unit 32b outputs the immediately preceding off-event signal Eoff to the readout line VSLb. Furthermore, the control unit 40 determines whether or not to perform the reset operation according to the off-event signal Eoff recorded in the recording unit 31b.

When the switching elements 302b, 303b, and 306b are on and the switching elements 301b, 304b, and 305b are off, the recording unit 32b records the off-event signal Eoff, and the recording unit 31b outputs the immediately preceding off-event signal Eoff to the readout line VSLb. Furthermore, the control unit 40 determines whether or not to perform the reset operation according to the off-event signal Eoff recorded in the recording unit 32b.

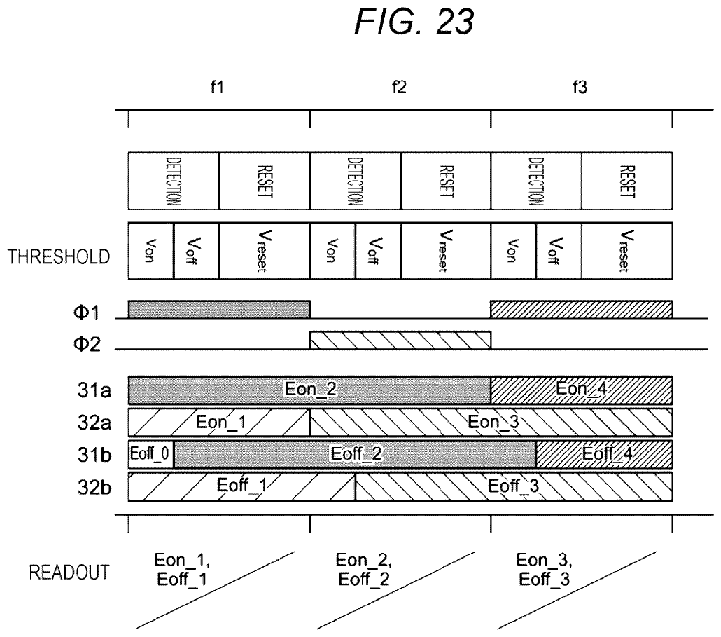

FIG. 23 is a timing diagram illustrating an operation example of the photodetection element 1 according to the eighth embodiment. The detection operation and the reset operation are basically the same as those of the first embodiment. However, according to the eighth embodiment, the switching elements 301a to 306a alternately switch the operation of the recording unit 31a and the operation of the recording unit 32a between the recording operation of the on-event signal Eon and the readout operation of the on-event signal Eon. The switching elements 301b to 306b alternately switch the operation of the recording unit 31b and the operation of the recording unit 32b between the recording operation of the off-event signal Eoff and the readout operation of the off-event signal Eoff.

A signal Φ1 is a control signal for the switching elements 301a, 304a, and 305a and the switching elements 301b, 304b, and 305b.

A signal Φ2 is a control signal for the switching elements 302a, 303a, and 306a and the switching elements 302b, 303b, and 306b.

In the frame f1, the signal Φ1 is activated and the signal Φ2 is inactive. Therefore, the switching elements 301a, 304a, and 305a are turned on, and the switching elements 302a, 303a, and 306a are turned off. Therefore, the recording unit 31a records the on-event signal Eon_2. The recording unit 32a outputs, to the readout line VSLa, the on-event signal Eon_1 recorded immediately before the on-event signal Eon_2. Furthermore, the control unit 40 performs or does not perform the reset operation according to the on-event signal Eon_2 recorded in the recording unit 31a.

Furthermore, the switching elements 301b, 304b, and 305b are turned on, and the switching elements 302b, 303b, and 306b are turned off. Therefore, the recording unit 31b records the off-event signal Eoff_2. The recording unit 32b outputs, to the readout line VSLb, the off-event signal Eoff_1 recorded immediately before the off-event signal Eoff_2. Furthermore, the control unit 40 performs or does not perform the reset operation according to the off-event signal Eoff_2 recorded in the recording unit 31b.

In the next frame f2, the signal Φ2 is activated and the signal Φ1 becomes inactive. Therefore, the switching elements 301a, 304a, and 305a are turned off, and the switching elements 302a, 303a, and 306a are turned on. Therefore, the recording unit 31a outputs the on-event signal Eon_2 to the readout line VSLa. The recording unit 32a records an on-event signal Eon_3. Furthermore, the control unit 40 performs or does not perform the reset operation according to the on-event signal Eon_3 recorded in the recording unit 32a.

Furthermore, the switching elements 301b, 304b, and 305b are turned off, and the switching elements 302b, 303b, and 306b are turned on. Therefore, the recording unit 31b outputs the off-event signal Eoff_2 to the readout line VSLb. The recording unit 32b records an off-event signal Eoff_3. Furthermore, the control unit 40 performs or does not perform the reset operation according to the off-event signal Eoff_3 recorded in the recording unit 32b.

In the next frame f3, the signal Φ1 is activated again and the signal Φ2 becomes inactive again. Therefore, the switching elements 301a, 304a, and 305a are turned on, and the switching elements 302a, 303a, and 306a are turned off. Therefore, the recording unit 31a records an on-event signal Eon_4. The recording unit 32a outputs the on-event signal Eon_3 to the readout line VSLa. Furthermore, the control unit 40 performs or does not perform the reset operation according to the on-event signal Eon_4 recorded in the recording unit 31a.

Furthermore, the switching elements 301b, 304b, and 305b are turned on, and the switching elements 302b, 303b, and 306b are turned off. Therefore, the recording unit 31b records an off-event signal Eoff_4. The recording unit 32b outputs the off-event signal Eoff_3 to the readout line VSLb. Furthermore, the control unit 40 performs or does not perform the reset operation according to the off-event signal Eoff_4 recorded in the recording unit 31b.

As described above, the recording units 31a and 32a according to the eighth embodiment are connected in parallel between the comparator 336 and the readout line VSLa. The recording units 31b and 32b are connected in parallel between the comparator 336 and the readout line VSLb. Furthermore, the switching elements 301a to 306a and 301b to 306b are provided. Therefore, the recording units 31a and 32a alternately record the on-event signal Eon and alternately read out the recorded on-event signal Eon to the readout line VSLa. The recording units 31b and 32b alternately record the off-event signal Eoff and alternately read out the recorded off-event signal Eoff to the readout line VSLb.

The other configurations and operations of the eighth embodiment may be similar to those of the first embodiment. According to the eighth embodiment, in the reset operation and the detection operation, the readout operation of the event signal Eon or Eoff can be redundantly executed. Thus, the eighth embodiment can obtain effects similar to those of the first embodiment.

### (Application Example to Mobile Body)

The technology according to the present disclosure (present technology) can be applied to various electronic apparatuses. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

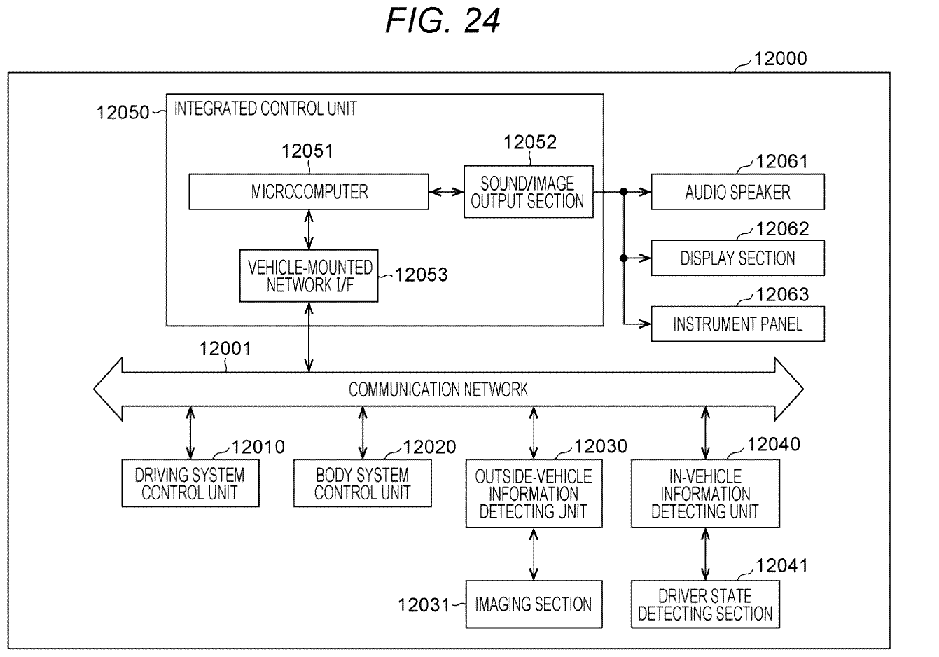

FIG. 24 is a block diagram illustrating an example of a schematic configuration of a vehicle control system as an example of a mobile object control system to which the technology of the present disclosure can be applied.

The vehicle control system 12000 includes a plurality of electronic control units connected to each other via a communication network 12001. In the example illustrated in FIG. 24, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs.

For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit. 12030 detects information about the outside of the vehicle including the vehicle control system 12000, For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 24, an audio speaker 12061, a display section 12062, and an instrument panel 12063 are depicted as the output device. The display section 12062 may, for example, include at least one of an on-board display and a head-up display.

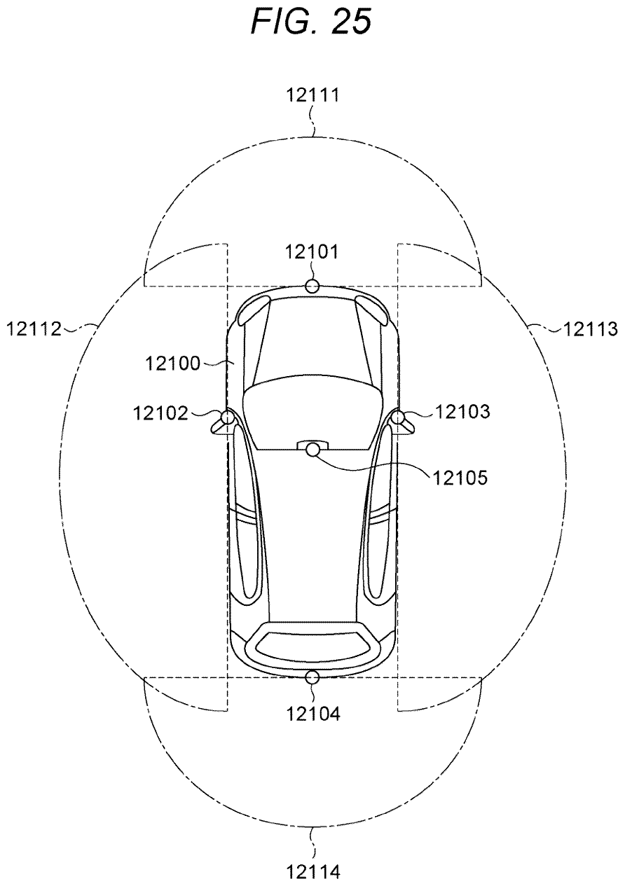

FIG. 25 is a diagram illustrating an example of installation positions of the imaging section 12031.

In FIG. 25, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 25 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like, for example, among the configurations described above.

Note that the present technology can also employ the following configurations.

(1)

A photodetection element including:
a light receiving unit that photoelectrically converts incident light to generate an electric signal;
a comparison unit which outputs an event signal when an amount of change in the electric signal exceeds or falls below a threshold;
a first recording unit that is connected to an output terminal of the comparison unit, records the event signal, and outputs the event signal; and
a second recording unit that is connected to the first recording unit, records the event signal from the first recording unit, and outputs the event signal.
   (2)

The photodetection element according to (1), in which the first recording unit records a next event signal from the comparison unit during a readout period in which the event signal recorded in the second recording unit is being read out.

(3)

The photodetection element according to (1) or (2), further including:
a first switching element that is connected between an input terminal of the comparison unit and the output terminal of the comparison unit;
a control unit that is provided between an output terminal of the first recording unit and the first switching element and controls the first switching element on the basis of the event signal output from the first recording unit; and
a first readout line that is connected to an output terminal of the second recording unit, in which
when the first switching element is in a conductive state, the second recording unit outputs the event signal to the first readout line.
   (4)

The photodetection element according to any one of (1) to (3), further including:
a third recording unit that is connected to the output terminal of the comparison unit and records the event signal; and
a fourth recording unit that is connected to the third recording unit and records the event signal from the third recording unit.
   (5)

The photodetection element according to (4), in which the third recording unit records a next event signal from the comparison unit during a readout period in which the event signal recorded in the fourth recording unit is being read out.

(6)

The photodetection element according to (4) or (5), further including:
a first switching element that is connected between an input terminal of the comparison unit and the output terminal of the comparison unit;
a control unit that is provided between output terminals of the first and third recording units and the first switching element and controls the first switching element on the basis of the event signal output from the first and third recording units;
a first readout line that is connected to an output terminal of the second recording unit; and
a second readout line that is connected to an output terminal of the fourth recording unit, in which
when the first switching element is in a conductive state, the event signal recorded in the second recording unit is read out to the first readout line, and the event signal recorded in the fourth recording unit is read out to the second readout line.
   (7)

The photodetection element according to (6), in which
the comparison unit compares the amount of change with a first threshold and outputs a first event signal in a first period, and compares the amount of change with a second threshold different from the first threshold and outputs a second event signal in a second period following the first period,
the first recording unit records the first event. signal in the first period,
the third recording unit records the second event signal in the second period, and
when the first switching element is in a conductive state, the second recording unit records the first event signal from the first recording unit and outputs the first event signal to the first readout line, and the fourth recording unit records the second event signal from the third recording unit and outputs the second event signal to the second readout line.
   (8)

The photodetection element according to (7), in which the control unit resets voltages at an input terminal and an output terminal of the comparison unit to a voltage between the first threshold and the second threshold by bringing the first switching element into a conductive state.

(9)

The photodetection element according to (6), in which the control unit controls the first switching element on the basis of the event signal recorded in each of the first and third recording units.

(10)

The photodetection element according to (3), further including:
an inverter that is connected to an output terminal of one of the first and second recording units; and
a first logic gate that outputs, to the first readout line, a logical AND of an output signal of another of the first and second recording units and an output signal of the inverter.
   (11)

The photodetection element according to (6), further including:
an inverter that is connected to an output terminal of one of the first and second recording units;
a first logic gate that outputs, to the first readout line, a logical AND of an output signal of another of the first and second recording units and an output signal of the inverter;
an inverter that is connected to an output terminal of one of the third and fourth recording units; and
a second logic gate that outputs, to the second readout line, a logical AND of an output signal of another of the third and fourth recording units and the output signal of the inverter.
   (12)

The photodetection element according to (3), further including:
a third logic gate that outputs a logical AND of output signals of the first and second recording units to the control unit, in which
the control unit controls the first switching element on the basis of an output signal of the third logic gate.
   (13)

The photodetection element according to (6), further including:
a third logic gate that outputs a logical AND of output signals of the first and second recording units to the control unit; and
a fourth logic gate that outputs a logical AND of output signals of the third and fourth recording units to the control unit, in which
the control unit controls the first switching element on the basis of output signals of the third and fourth logic gates.
   (14)

The photodetection element according to (3), in which
the comparison unit compares the amount of change with a first threshold and outputs a first event signal in a first period, and compares the amount of change with a second threshold different from the first threshold and outputs a second event signal in a second period following the first period,
the first recording unit alternately records the first event signal and the second event signal, and
when the first switching element is in a conductive state, the second recording unit records the first event signal from the first recording unit and outputs the first event signal to the first readout line, or records the second event signal from the first recording unit and outputs the second event signal to the first readout line.
   (15)

The photodetection element according to any one of (4), (5), (12), or (13), further including:
a first switching element that is connected between an input terminal of the comparison unit and the output terminal of the comparison unit;
a control unit that is provided between the output terminals of the first and third recording units and the first switching element and controls the first switching element on the basis of the event signal output from the first and third recording units;
a first switch circuit that is connected to output terminals of the second and fourth recording units; and
a first readout line that is connected to an output terminal of the first switch circuit, in which
the first switch circuit selectively connects the output terminal of any one of the second and fourth recording units to the first readout line.
   (16)

The photodetection element according to any one of (1) to (16), further including:
a plurality of the light receiving units;
a plurality of the comparison units that is provided corresponding to the plurality of light receiving units;
a plurality of the first recording units;
a plurality of the second recording units that is provided corresponding to the plurality of first recording units;
a buffer that is provided between the plurality of comparison units and the plurality of first recording units;
a second switch circuit that is provided between an input terminal of the buffer and the plurality of comparison units, and connects a selected comparison unit selected from the plurality of comparison units to the input terminal of the buffer; and
a third switch circuit that is provided between an output terminal of the buffer and the plurality of first recording units and connects a selected first recording unit selected from the plurality of first recording units to the output terminal of the buffer.
   (17)

A photodetection element including:
a light receiving unit that photoelectrically converts incident light to generate an electric signal;
a comparison unit that compares an amount of change in the electrical signal generated by the light receiving unit with a threshold and outputs an event signal; and
first and second recording units that are connected in parallel to an output terminal of the comparison unit, in which
when one of the first and second recording units records the event signal, another of the first and second recording units outputs the event signal.
   (18)

The photodetection element according to claim 17, further including:
a second switching element that is connected between the output terminal of the comparison unit and the first recording unit;
a third switching element that is connected between the output terminal of the comparison unit and the second recording unit;
a fourth switching element that is connected between the first recording unit and the first readout line;
a fifth switching element that is connected between the second recording unit and the first readout line;
a sixth switching element that is connected between the first recording unit and the control unit; and
a seventh switching element that is connected between the second recording unit and the control unit, in which
when the first recording unit records the event signal and the second recording unit outputs the event signal, the second, fifth, and sixth switching elements are in a conductive state, and the third, fourth, and seventh switching elements are in a non-conductive state, and
when the second recording unit records the event signal and the first recording unit outputs the event signal, the third, fourth, and seventh switching elements are in a conductive state, and the second, fifth, and sixth switching elements are in a non-conductive state.
   (19)

An electronic apparatus including:
a photodetection element including
a light receiving unit that photoelectrically converts incident light to generate an electric signal,
a comparison unit which outputs an event signal when an amount of change in the electric signal exceeds or falls below a threshold,
a first recording unit that is connected to an output terminal of the comparison unit, records the event signal, and outputs the event signal, and
a second recording unit that is connected to the first recording unit, records the event signal from the first recording unit, and outputs the event signal.
   (20)

An electronic apparatus including:
a photodetection element including
a light receiving unit that photoelectrically converts incident light to generate an electric signal,
a comparison unit that compares an amount of change in the electrical signal generated by the light receiving unit with a threshold and outputs an event signal, and
first and second recording units that are connected in parallel to an output terminal of the comparison unit, in which
when one of the first and second recording units records the event signal, another of the first and second recording units outputs the event signal.

Note that the present disclosure is not limited to the above-described embodiments, and various modifications can be made without departing from the gist of the present disclosure. Furthermore, the effects described in the present description are merely examples and are not limited, and other effects may be provided.

### REFERENCE SIGNS LIST

30 Recording region
40 Control unit
221 Light receiving unit
300 Event detection circuit
310 Logarithmic conversion circuit
320 Buffer
330 Quantizer
331 Capacitor
332, 333, 334, 335 Switching element
336 Comparator
31a, 32a, 31b, 32b Recording unit

1. A photodetection element comprising:
a light receiving unit that photoelectrically converts incident light to generate an electric signal;
a comparison unit which outputs an event signal when an amount of change in the electric signal exceeds or falls below a threshold;
a first recording unit that is connected to an output terminal of the comparison unit, records the event signal, and outputs the event signal; and
a second recording unit that is connected to the first recording unit, records the event signal from the first recording unit, and outputs the event signal.

2. The photodetection element according to claim 1, wherein the first recording unit records a next event. signal from the comparison unit during a readout period in which the event signal recorded in the second recording unit is being read out.

3. The photodetection element according to claim 1, further comprising:
a first switching element that is connected between an input terminal of the comparison unit and the output terminal of the comparison unit;
a control unit that is provided between an output terminal of the first recording unit and the first switching element and controls the first switching element on a basis of the event signal output from the first recording unit; and
a first readout line that is connected to an output terminal of the second recording unit, wherein
when the first switching element is in a conductive state, the second recording unit outputs the event signal to the first readout line.

4. The photodetection element according to claim 1, further comprising:
a third recording unit that is connected to the output terminal of the comparison unit and records the event signal; and
a fourth recording unit that is connected to the third recording unit and records the event signal from the third recording unit.

5. The photodetection element according to claim 4, wherein the third recording unit records a next event signal from the comparison unit during a readout period in which the event signal recorded in the fourth recording unit is being read out.

6. The photodetection element according to claim 4, further comprising:
a first switching element that is connected between an input terminal of the comparison unit and the output terminal of the comparison unit;
a control unit that is provided between output terminals of the first and third recording units and the first switching element and controls the first switching element on a basis of the event signal output from the first and third recording units;
a first readout line that is connected to an output terminal of the second recording unit; and
a second readout line that is connected to an output terminal of the fourth recording unit, wherein
when the first switching element is in a conductive state, the event signal recorded in the second recording unit is read out to the first readout line, and the event signal recorded in the fourth recording unit is read out to the second readout line.

7. The photodetection element according to claim 6, wherein
the comparison unit compares the amount of change with a first threshold and outputs a first event signal in a first period, and compares the amount of change with a second threshold different from the first threshold and outputs a second event signal in a second period following the first period,
the first recording unit records the first event. signal in the first period,
the third recording unit records the second event signal in the second period, and
when the first switching element is in a conductive state, the second recording unit records the first event signal from the first recording unit and outputs the first event signal to the first readout line, and the fourth recording unit records the second event signal from the third recording unit and outputs the second event signal to the second readout line.

8. The photodetection element according to claim 7, wherein the control unit resets voltages at an input terminal and an output terminal of the comparison unit to a voltage between the first threshold and the second threshold by bringing the first switching element into a conductive state.

9. The photodetection element according to claim 6, wherein the control unit controls the first switching element on a basis of the event signal recorded in each of the first and third recording units.

10. The photodetection element according to claim 3, further comprising:
an inverter that is connected to an output terminal of one of the first and second recording units; and
a first logic gate that outputs, to the first readout line, a logical AND of an output signal of another of the first and second recording units and an output signal of the inverter.

11. The photodetection element according to claim 6, further comprising:
an inverter that is connected to an output terminal of one of the first and second recording units;
a first logic gate that outputs, to the first readout line, a logical AND of an output signal of another of the first and second recording units and an output signal of the inverter;
an inverter that is connected to an output terminal of one of the third and fourth recording units; and
a second logic gate that outputs, to the second readout line, a logical AND of an output signal of another of the third and fourth recording units and the output signal of the inverter.

12. The photodetection element according to claim 3, further comprising:
a third logic gate that outputs a logical AND of output signals of the first and second recording units to the control unit, wherein
the control unit controls the first switching element on a basis of an output signal of the third logic gate.

13. The photodetection element according to claim 6, further comprising:
a third logic gate that outputs a logical AND of output signals of the first and second recording units to the control unit; and
a fourth logic gate that outputs a logical AND of output signals of the third and fourth recording units to the control unit, wherein
the control unit controls the first switching element on a basis of output signals of the third and fourth logic gates.

14. The photodetection element according to claim 3, wherein
the comparison unit compares the amount of change with a first threshold and outputs a first event signal in a first period, and compares the amount of change with a second threshold different from the first threshold and outputs a second event signal in a second period following the first period,
the first recording unit alternately records the first event signal and the second event signal, and
when the first switching element is in a conductive state, the second recording unit records the first event signal from the first recording unit and outputs the first event signal to the first readout line, or records the second event signal from the first recording unit and outputs the second event signal to the first readout line.

15. The photodetection element according to claim 4, further comprising:
a first switching element that is connected between an input terminal of the comparison unit and the output terminal of the comparison unit;
a control unit that is provided between the output terminals of the first and third recording units and the first switching element and controls the first switching element on a basis of the event signal output from the first and third recording units;
a first switch circuit that is connected to output terminals of the second and fourth recording units; and
a first readout line that is connected to an output terminal of the first switch circuit, wherein
the first switch circuit selectively connects the output terminal of any one of the second and fourth recording units to the first readout line.

16. The photodetection element according to claim 1, further comprising:
a plurality of the light receiving units;
a plurality of the comparison units that is provided corresponding to the plurality of light receiving units;
a plurality of the first recording units;
a plurality of the second recording units that is provided corresponding to the plurality of first recording units;
a buffer that is provided between the plurality of comparison units and the plurality of first recording units;
a second switch circuit that is provided between an input terminal of the buffer and the plurality of comparison units, and connects a selected comparison unit. selected from the plurality of comparison units to the input terminal of the buffer; and
a third switch circuit that is provided between an output terminal of the buffer and the plurality of first recording units and connects a selected first recording unit selected from the plurality of first recording units to the output terminal of the buffer.

17. A photodetection element comprising:
a light receiving unit that photoelectrically converts incident light to generate an electric signal;
a comparison unit that compares an amount of change in the electrical signal generated by the light receiving unit with a threshold and outputs an event signal; and
first and second recording units that are connected in parallel to an output terminal of the comparison unit, wherein
when one of the first and second recording units records the event signal, another of the first and second recording units outputs the event signal.

18. The photodetection element according to claim 17, further comprising:
a first switching element that is connected between an input terminal of the comparison unit and the output terminal of the comparison unit;
a control unit that is provided between output terminals of the first and second recording units and the first switching element and controls the first switching element on a basis of the event signal output from the first or second recording unit;
a first readout line that is provided on an output terminal side of the first and second recording units;
a second switching element that is connected between the output terminal of the comparison unit and the first recording unit;
a third switching element that is connected between the output terminal of the comparison unit and the second recording unit;
a fourth switching element that is connected between the first recording unit and the first readout line;
a fifth switching element that is connected between the second recording unit and the first readout line;
a sixth switching element that is connected between the first recording unit and the control unit; and
a seventh switching element that is connected between the second recording unit and the control unit, wherein
when the first recording unit records the event signal and the second recording unit outputs the event signal, the second, fifth, and sixth switching elements are in a conductive state, and the third, fourth, and seventh switching elements are in a non-conductive state, and
when the second recording unit records the event signal and the first recording unit outputs the event signal, the third, fourth, and seventh switching elements are in a conductive state, and the second, fifth, and sixth switching elements are in a non-conductive state.

19. An electronic apparatus comprising:
a photodetection element including
a light receiving unit that photoelectrically converts incident light to generate an electric signal,
a comparison unit which outputs an event signal when an amount of change in the electric signal exceeds or falls below a threshold,
a first recording unit that is connected to an output terminal of the comparison unit, records the event signal, and outputs the event signal, and
a second recording unit that is connected to the first recording unit, records the event signal from the first recording unit, and outputs the event signal.

20. An electronic apparatus comprising:
a photodetection element including
a light receiving unit that photoelectrically converts incident light to generate an electric signal,
a comparison unit that compares an amount of change in the electrical signal generated by the light receiving unit with a threshold and outputs an event signal, and
first and second recording units that are connected in parallel to an output terminal of the comparison unit, wherein
when one of the first and second recording units records the event signal, another of the first and second recording units outputs the event signal.
